(19) United States
(12) Patent Application Publication
(10) Pub. No.: US 2023/0409558 A1
(43) Pub. Date: Dec. 21, 2023

(54) SYSTEMS, METHODS, AND STORAGE MEDIA FOR VERIFYING DATA

(71) Applicant: Data Sentinel AI, Inc., Denver, CO (US)

(72) Inventors: Kevin Wysocki, Denver, CO (US); Scott Hagen, Osceola, WI (US); Yindong Yu, Chicago, IL (US); Maigari Jinkiri, Austin, TX (US)

(21) Appl. No.: 17/844,250

(22) Filed: Jun. 20, 2022

(51) Int. Cl. G06F 16/23

(52) U.S. Cl. CPC G06F 16/2365

(57) ABSTRACT

Systems, methods, and storage media for verifying data are disclosed. Exemplary implementations may: capture data associated with a plurality of computing device first events; obtain one or more allowable data values associated with the plurality of computing device first events; interact with the computing device in one or more second events; generate new data values associated with the one or more second events; and verify whether the new data values comprise at least one of the allowable data values.

### FIELD OF THE DISCLOSURE

The present disclosure relates to systems, methods, and storage media for verifying data.

### BACKGROUND

Existing methods of validating data include using an automated, non-human, robot or service to visit a webpage or mobile app and crawl a website, and validate the data generated by visiting the pages. The data generated and validated is only for the single fake user, not all devices that are accessing the digital asset around the world. The reporting and alerting does not happen in real time because a user must configure how often the scan must run. Frequently, this may be once per day or once per week.

Software programs that rely on data generated by all devices accessing the digital asset to produce reports cannot be deemed valid or correct if only one of the infinite number of data points is validated. The old method relies on validating the data generated from a single, non-human user. Additionally, because specific instructions are needed to perform actions on a web page that are more than just loading the page or scrolling, only pre-defined test cases are possible in existing methods. In the real world, users going to a website do not perform per-described actions, they interact with the website in ways that the original designers could not have foreseen and therefore the types of data generated can be different and not what is expected.

In addition, existing technologies do not store every possible value for every single data point used by every single technology and utilize that stored data to drive alerting and anomaly detection.

The description provided in the Background section should not be assumed to be prior art merely because it is mentioned in or associated with this section. The Background section may include information that describes one or more aspects of the subject technology.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Broadly, aspects of the disclosure are directed to a system that helps ensure that data being passed from a web page, mobile application, or server, to another server, is valid and as expected for every device that interacts with the web page, mobile application, or server. The system described herein comprises a system for validating all the data being created by every device interacting with the digital asset, at the precise moment of data collection. In some cases, this validation is performed in real time (or substantially real-time), for instance, after a request is passed. In some cases, the system generates the expected data, which is then used to detect changes via static or dynamic analysis. If an anomaly is detected, the data is passed to a data collection endpoint, which sends an alert to notify a user of the anomaly or discrepancy in the data. In addition to validating the data being passed in a request, the system may also validate data returned in a response (i.e., in response to the request). In some examples, this validation may be based on assessing one or more of the data sent and data returned (response from the server), user interactions, a document object model (DOM) state, and user consent (e.g., provided by the user to allow/restrict certain personally identifiable information and/or technology types and categories from being collected).

In some examples, the disclosed system enhances the validation process for data being generated by one or more users/devices accessing a digital asset, such as a website, as compared to the prior art. As noted above, prior art techniques often rely on the use of a pre-configured crawler for validating/verifying data. However, by directly implementing the data validation/verification algorithm into the digital asset being accessed, for all users, the system of the present disclosure serves to provide a more robust and wider validation process than seen in the prior art. In some examples, the data validation/verification algorithm may be directly deployed (or built into) on the digital asset (e.g., a web page, mobile app, or server processing environment) being accessed. That is, in some cases, the data validation/verification algorithm is executed on one or more user devices (e.g., smart phone, laptop, computer, etc.) that access the digital asset. When the digital asset is loaded and accessed on a user device, the system monitors one or more of network requests for data that are sent to endpoints, user interactions, changes to the DOM, and values in the DOM. It is contemplated that for systems such as, but not limited to, mobile and server-side applications and functionality that do not comprise DOMs, the system may instead monitor a current state of variables, and configurations inside the application and the term DOM, as used herein, may refer to such aspects, where appropriate. Furthermore, upon detecting an event, such as, but not limited to, a network request, user interaction, and/or change to the DOM, the system attempts to validate the data generated by the event. In some examples, the system checks the request for missing, malformed, unexpected, or new data points. In some cases, the system creates an anomaly event, for example, upon detecting a discrepancy between the collected data and the expected data. The system may further process the captured (or collected) data, which may allow for real time alerting via email, text, and/or push notifications, to name a few non-limiting examples.

In some embodiments, the system is configured to validate data for one or more users interacting with a website, mobile app, or server API, for example, via a user device. Additionally, or alternatively, the system is configured to provide real time alerting upon detecting one or more data anomalies (e.g., based on a discrepancy between the collected or captured data and the expected data). In some cases, the system is also configured to detect consent violations. As used herein, the term “consent violation” may refer to an instance when a user's actions (e.g., viewing a page, clicking a link, etc.) while visiting a digital asset are tracked and/or when the user's data (e.g., personally identifiable information or PII) is sent after the user has revoked consent to be tracked. In some cases, the system of the present disclosure is also configured to generate the source of truth (SOT), where the SOT is used to implement the validation algorithm.

One aspect of the present disclosure relates to a system configured for verifying data. The system may include one or more hardware processors configured by machine-readable instructions. The processor(s) may be configured to generate one or more data values associated with one or more computing device interactions. The processor(s) may be configured to work with one or more other aspects of the computing device to (optionally) transmit the one or more the data values from the computing device. The processor(s) may be configured to apply validation rules to the one or more data values. The processor(s) may be configured to use the validation rules to verify whether at least one of the one or more data values comprises at least one allowable data value.

Another aspect of the present disclosure relates to a method for verifying data. The method may include capturing data associated with a plurality of computing device first events. The method may include obtaining at least one allowable data value associated with the plurality of computing device first events. The method may include interacting with the computing device in one or more second events. The method may include generating new data values associated with the one or more second events. The method may include (optionally) transmitting from the computing device the new data values. The method may include verifying whether the new data values include at least one of the at least one allowable data value.

Yet another aspect of the present disclosure relates to a non-transient computer-readable storage medium having instructions embodied thereon, the instructions being executable by one or more processors to perform a method for verifying data. The method may include capturing data associated with a plurality of computing device first events. The method may include obtaining one or more allowable data values associated with the plurality of computing device first events. The method may include interacting with the computing device in one or more second events. The method may include generating new data values associated with the one or more second events. The method may include (optionally) transmitting the new data values from the computing device. The method may include verifying whether the new data values include at least one of the at least one allowable data value.

Another aspect of the present disclosure relates to a system configured for verifying consent, the system comprising one or more hardware processors configured by machine-readable instructions to: generate one or more data values associated with one or more computing device interactions, transmit the one or more data values from the computing device, apply consent rules to the one or more data values, and use the consent rules to verify whether a user has at least one of granted consent and denied consent to transmit the at least one of the one or more data values.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of ‘a’, ‘an’, and ‘the’ include plural referents unless the context clearly dictates otherwise.

### BRIEF DESCRIPTION OF THE DRAWINGS

FIG. 1 illustrates a system configured for verifying data, in accordance with one or more implementations.

FIG. 2A illustrates a method for verifying data, in accordance with one or more implementations.

FIG. 2B illustrates a method for data collection, in accordance with one or more implementations

FIG. 2C illustrates a method for consent validation, in accordance with one or more implementations.

FIG. 2D illustrates a method for validating personally identifiable information or PII, in accordance with one or more implementations.

FIG. 2E illustrates a method for source of truth or SOT validation, in accordance with one or more implementations.

FIG. 3 illustrates a diagrammatic representation of a system configured for verifying data, in accordance with various aspects of the disclosure.

FIG. 4 illustrates a block diagram of a computer system configured for verifying data, in accordance with various aspects of the disclosure.

FIG. 5 illustrates an example of a report generated by the system in FIG. 3, according to various aspects of the disclosure

FIG. 6 illustrates another example of a report generated by the system in FIG. 3, according to various aspects of the disclosure

FIG. 7 illustrates yet another example of a report generated by the system in FIG. 3, according to various aspects of the disclosure.

### DETAILED DESCRIPTION

In the following detailed description, references are made to the accompanying drawings that form a part hereof, and in which are shown by way of illustrations or specific examples. These aspects may be combined, other aspects may be utilized, and structural changes may be made without departing from the present disclosure. Example aspects may be practiced as methods, systems, or devices. Accordingly, example aspects may take the form of a hardware implementation, a software implementation, or an implementation combining software and hardware aspects. The following detailed description is therefore not to be taken in a limiting sense, and the scope of the present disclosure is defined by the appended claims and their equivalents.

The words “for example” is used herein to mean “serving as an example, instant, or illustration.” Any embodiment described herein as “for example” or any related term is not necessarily to be construed as preferred or advantageous over other embodiments. Additionally, a reference to a “device” is not meant to be limiting to a single such device. It is contemplated that numerous devices may comprise a single “device” as described herein.

The embodiments described below are not intended to limit the disclosure to the precise form disclosed, nor are they intended to be exhaustive. Rather, the embodiment is presented to provide a description so that others skilled in the art may utilize its teachings. Technology continues to develop, and elements of the described and disclosed embodiments may be replaced by improved and enhanced items, however the teaching of the present disclosure inherently discloses elements used in embodiments incorporating technology available at the time of this disclosure.

The detailed descriptions which follow are presented in part in terms of algorithms and symbolic representations of operations on data within a computer memory wherein such data often represents numerical quantities, alphanumeric characters or character strings, logical states, data structures, or the like. A computer generally includes one or more processing mechanisms for executing instructions, and memory for storing instructions and data.

When a general-purpose computer has a series of machine-specific encoded instructions stored in its memory, the computer executing such encoded instructions may become a specific type of machine, namely a computer particularly configured to perform the operations embodied by the series of instructions. Some of the instructions may be adapted to produce signals that control operation of other machines and thus may operate through those control signals to transform materials or influence operations far removed from the computer itself. These descriptions and representations are the means used by those skilled in the data processing arts to convey the substance of their work most effectively to others skilled in the art.

The term algorithm as used herein, and generally in the art, refers to a self-consistent sequence of ordered steps that culminate in a desired result. These steps are those requiring manipulations of physical quantities. Usually, though not necessarily, these quantities take the form of electrical or magnetic pulses or signals capable of being stored, transferred, transformed, combined, compared, and otherwise manipulated. It is often convenient for reasons of abstraction or common usage to refer to these signals as bits, values, symbols, characters, display data, terms, numbers, or the like, as signifiers of the physical items or manifestations of such signals. It should be borne in mind, however, that all of these and similar terms are to be associated with the appropriate physical quantities and are merely used here as convenient labels applied to these quantities.

Some algorithms may use data structures for both inputting information and producing the desired result. Data structures facilitate data management by data processing systems and are not accessible except through sophisticated software systems. Data structures are not the information content of a memory, rather they represent specific electronic structural elements which impart or manifest a physical organization on the information stored in memory. More than mere abstraction, the data structures are specific electrical or magnetic structural elements in memory which simultaneously represent complex data accurately, often data modeling physical characteristics of related items, and provide increased efficiency in computer operation. By changing the organization and operation of data structures and the algorithms for manipulating data in such structures, the fundamental operation of the computing system may be changed and improved.

In the descriptions herein, operations and manipulations are often described in terms, such as comparing, sorting, selecting, or adding, which are commonly associated with mental operations performed by a human operator. It should be understood that these terms are employed to provide a clear description of an embodiment of the present invention, and no such human operator is necessary, nor desirable in most cases.

This requirement for machine implementation for the practical application of the algorithms is understood by those persons of skill in this art as not a duplication of human thought, rather as significantly more than such human capability. Useful machines for performing the operations of one or more embodiments of the present invention include general purpose digital computers or other similar devices. In all cases the distinction between the method operations in operating a computer and the method of computation itself should be recognized. One or more embodiments of present invention relate to methods and apparatus for operating a computer in processing electrical or other (e.g., mechanical, chemical) physical signals to generate other desired physical manifestations or signals. The computer operates on software modules, which are collections of signals stored on a media that represents a series of machine instructions that enable the computer processor to perform the machine instructions that implement the algorithmic steps. Such machine instructions may be the actual computer code the processor interprets to implement the instructions, or alternatively may be a higher-level coding of the instructions that is interpreted to obtain the actual computer code. The software module may also include a hardware component, wherein some aspects of the algorithm are performed by the circuitry itself rather as a result of an instruction.

Some embodiments of the present invention rely on an apparatus for performing disclosed operations. This apparatus may be specifically constructed for the required purposes, or it may comprise a general purpose or configurable device, such as a computer selectively activated or reconfigured by a program comprising instructions stored to be accessible by the computer. The algorithms presented herein are not inherently related to any particular computer or other apparatus unless explicitly indicated as requiring particular hardware. In some cases, the computer programs may communicate or interact with other programs or equipment through signals configured to particular protocols which may or may not require specific hardware or programming to accomplish. In particular, various general-purpose machines may be used with programs written in accordance with the teachings herein, or it may prove more convenient to construct more specialized apparatus to perform the required method steps. The required structure for a variety of these machines will be apparent from the description below.

In the following description, several terms which are used frequently have specialized meanings in the present context.

In the description of embodiments herein, frequent use is made of the terms server, client, and client/server architecture. In this context, a server and client are each instantiations of a set of functions and capabilities intended to support distributed computing. These terms are often used to refer to a computer or computing machinery, yet it should be appreciated that the server or client function is provided by machine execution of program instructions, threads, modules, processes, or applications. The client computer and server computer are often, but not necessarily, geographically separated, although the salient aspect is that client and server each perform distinct, but complementary functions to accomplish a task or provide a service. The client and server accomplish this by exchanging data, messages, and often state information using a computer network, or multiple networks. It should be appreciated that in a client/server architecture for distributed computing, there are typically multiple servers and multiple clients, and they do not map to each other and further there may be more servers than clients or more clients than servers. A server is typically designed to interact with multiple clients.

In networks, bi-directional data communication (i.e., traffic) occurs through the transmission of encoded light, electrical, or radio signals over wire, fiber, analog, digital cellular, Wi-Fi, or personal communications service (PCS) media, or through multiple networks and media connected by gateways or routing devices. Signals may be transmitted through a physical medium such as wire or fiber, or via wireless technology using encoded radio waves. Much wireless data communication takes place across cellular systems using second generation technology such as code-division multiple access (CDMA), time division multiple access (TDMA), the Global System for Mobile Communications (GSM), Third Generation (wideband or 3G), Fourth Generation (broadband or 4G), Fifth Generation (5G), personal digital cellular (PDC), or through packet-data technology over analog systems such as cellular digital packet data (CDPD).

### Source of Truth

In some embodiments, the system (e.g., system 100, system 300) generates a source of truth (SOT), where the SOT is generated across the digital consumer data passed to and from data collection endpoints. In some cases, the system utilizes the SOT to detect one or more of missing data, malformed or incorrect data, and unexpected data. Initially, the SOT may be developed during a learning (or training) mode by capturing data and determining via rules, algorithms, and/or administrator or manual user input, the allowable data values. In some cases, the system, such as system 100, transmits an alert and/or generates a report when it detects data (e.g., new data) that is not part of the SOT. If the new data element or new vendor is indicated as “allowable”, e.g., by an administrator or user receiving the alert/report, the system may add information pertaining to the new data element (or new vendor) to the SOT. In such cases, the system 100 may refrain from sending alerts for the same (or similar) incidents in the future.

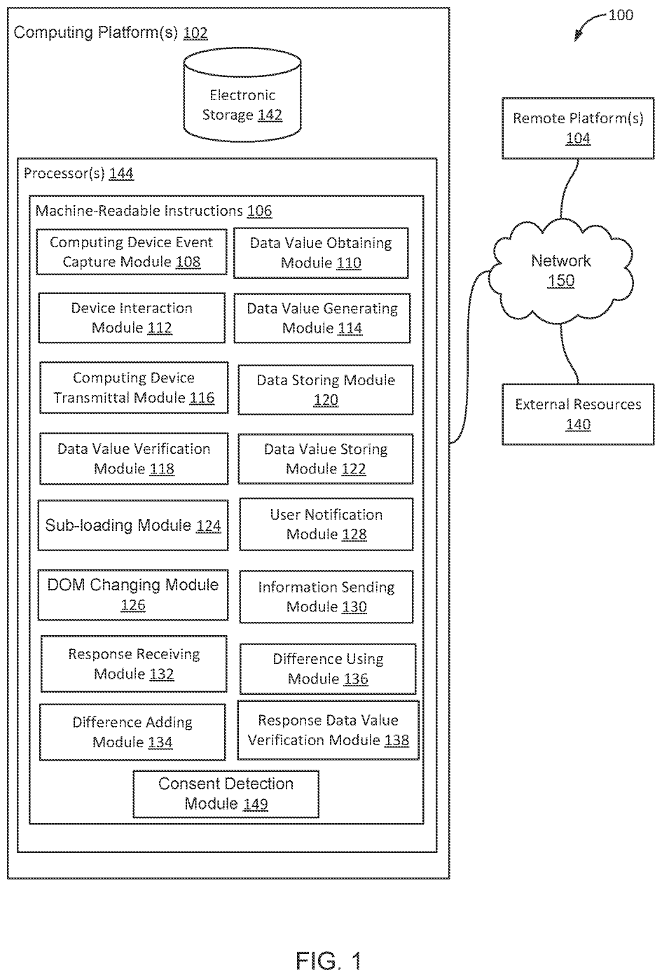

In some embodiments, when a web page (or alternatively, a web app or mobile app) is being loaded, the system 100 downloads and executes code, which is then executed on one or more user devices accessing the web page. The term “code” or “script” or “instructions” may be used interchangeably throughout the disclosure and may be used to refer to software instructions that are executable by one or more processors of a non-transient computer-readable storage medium. In some cases, executing the code (or instructions) may comprise downloading a configuration file from a remote server (e.g., external resources 140 in FIG. 1). In some implementations, the configuration file received from the remote server may dynamically change the operation of code. The script/code may include a plurality of configuration variables, one or more of which can change the operation of the script or impact how data is collected and processed by the system 100. In some examples, these configurable variables can be set from within a tag management system (TMS). A TMS may comprise a JavaScript (JS) file that is downloaded on a web page (or mobile app), where the JS file includes business logic of which tags/JS code should execute on a web page. Additionally, or alternatively, the TMS downloads one or more other files to execute tag logic. Execution of tag logic may cause the system (e.g., system 100, TMS) to download one or more other tags. Alternatively, these configuration variables can be remotely changed by updating a remote code file that changes the configuration variables. In the latter, no modifications/changes may be needed from the client and the configuration variables may be changed (e.g., using the remote code file) outside of the client's software release cycle, for example. In one non-limiting example, a “global.js” file containing configuration updates (e.g., for a core module), as well as global rules to check tags with, may be downloaded by the script.

Some non-limiting examples of configuration variables include one or more of (1) a unique ID assigned to the digital touchpoint (e.g., evg: 3ccbb438-b744-4cbb-b3c7-cda7baccc5bb), (2) an array of requests to ignore (e.g., excludeRegex: [new RegExp(“\hat{ }https:VV”+location.hostname),/\hat{ }https?:VV((fonts|ajax|maps|storage)\.(googleapis|gstatic)\.com|(apis|translate)\.google\.com|.*\.f ontawesome\.com|.*\.kaspersky-labs\.com|s7d2\.scene7\.com)/i], (3) a name of a data layer on a page (e.g., dataLayer: digitalData), (4) customized logic to determine how much data to sample (e.g., sampleFunc: function(urlObj, guid, sample) {if (guid, =“4de1916e-5e75-4a81-8c5a-fc0117c7c2d7”){return true;} else {return urlObj.p, “I” ? sample(0.01): sample(0.04);} }), (5) an indication of if a global configuration file should be downloaded (e.g., downloadGlobalFile: true), (6) an indication of if a page-specific SOT file should be downloaded (e.g., downloadPageFiles: true), (7) an indication of if general errors should be captured (e.g., trackGeneralErrors: true), (8) an indication of if JavaScript errors should be captured (e.g., trackJsErrors: true), (9) an array of PII rules (e.g., piiRules: [{name: “email”, pattern: /[\w-\.]+(@|%40)([\w-]+\.)+[\w-]{2,4}/}]) to check for personally identifiable information, such as email, phone, social security number or SSN, etc., and (10) logic to determine the unique hash of a digital touchpoint.

Additionally, the rules for developing the code/script/instructions can also be downloaded from a remote server on a global or per-page basis based on generating a hash of unique parts of the page URL, document object model (DOM) values, browser attributes, or user input. In some instances, the system 100 may take one or more input values available on the digital touchpoint, such as, but not limited to, a page URL, DOM values, browser attributes, and/or user input. One or more of these inputs may be combined to create a unique hash, which allows the digital touchpoint and the tag values associated with it to be uniquely identified. In some examples, each SOT is linked to a unique value/hash, which serves as a primary key for the input values. Once a unique hash/value is created from the input values, the system 100 may proceed to download a file with that unique hash. The unique hash may be associated with a unique hash name. Further, the system may download a file comprising the unique hash name, where the file includes the one or more SOT rules for that digital touchpoint. In some embodiments, the hash is updated, for example, if the number of inputs that make the webpage unique change. As an example, the hash for a webpage may be updated if the number of query string parameters defining the content on that webpage are also modified. For instance, the content on a webpage may be defined using four query string parameters. In such cases, the hash for that web page may be updated upon the addition of a fifth query string parameter.

In some embodiments, upon execution of the code/instructions (e.g., by one or more processing devices), the system 100 listens for new events (if any) occurring on the page. Some non-limiting examples of events include network requests, user interactions such as clicking, scrolling, typing, etc., changes to the DOM, and/or errors that get triggered. When a new event is detected by the system 100, depending on the mode of operation (e.g., capturing data mode, generating new data mode) of the script, the event can be ignored or filtered out, or the data about the event may be stored for further analysis. For example, the system 100 may capture the data about the event, such as, but not limited to, the URL of the request, the payload sent as part of the request, the response payload from the request, the timestamp, a randomized identifier, the value of a variable on the page, cookie names and or values, network performance information, and/or the path to an element on the web page. Additionally, or alternatively, the system 100 may compare the data passed via the algorithm to the expected data (for that event). In some examples, comparing the data may comprise “breaking down” or sub-dividing the data pertaining to the event into smaller sets of data, where the smaller sets of data are compared against the expected data. For example, if a request is being validated, the system 100 may split out different parts of the URL, such as, the protocol, domain, pathname, query string, data payload (e.g., a POST request), and/or hash fragment to compare with the expected data. In other cases, the system 100 may split out different parts of the URL and compare/analyze some of the elements (e.g., protocol, domain, pathname), but not others. Additionally, or alternatively, the system 100 may check the data for anomalies, new data points, and/or personal identifiable information (PII). The system 100 may also check if the consent given by the user allows the data (e.g., PII, or any other applicable information) to be captured in the first place. If issues are found, the system 100 captures one or more of the details of the issue (e.g., discrepancy between expected value and value found, pattern matched or not matched, the consent cookie, type of PII found, or other data points as described herein) and sends this information for collection. Optionally, the system 100 also transmits an alert based on the captured information.

### ALTERNATE EMBODIMENTS

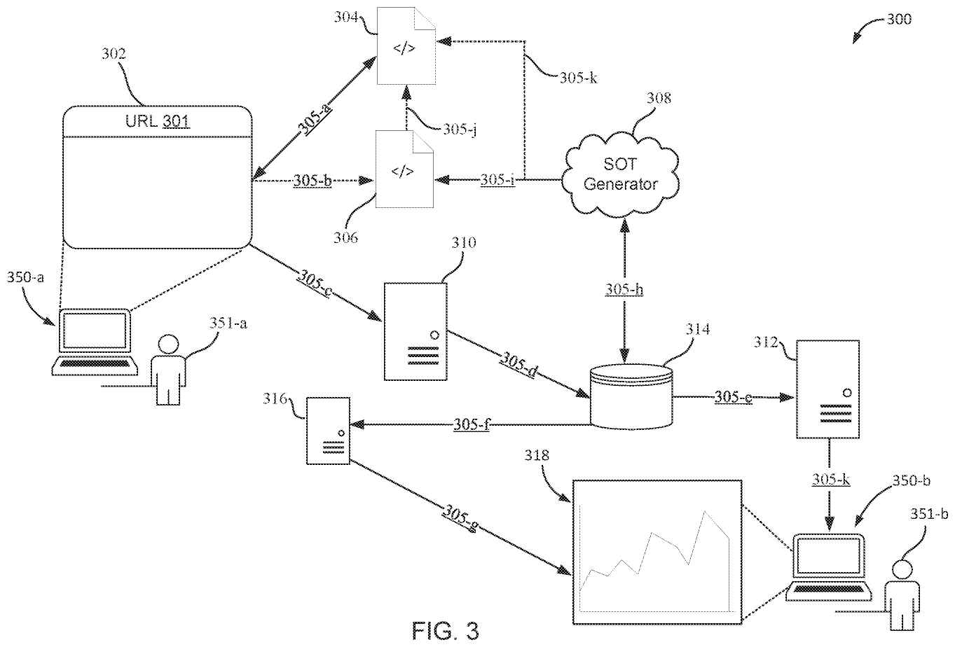

In some embodiments, the logic/script can be neutered (if instructed to) based on a configuration update. For instance, the script may be configured to disable its operation on a webpage when an error is detected, or when a client/user disables the functionality of the script via a code update (e.g., via the tag management system or TMS) or a server-side remote update. When PII is found, instead of collecting the sensitive information, the system 100 replaces the suspected PII with a placeholder of the suspected PII type. For instance, if the script was loaded on the URL “https://www.test.com?email=89hsahkjhjk@gmail.com”, instead of capturing the) PII in the URL (i.e., email=89hsahkjhjk@gmail.com), the system 100 may capture the URL as “https://www.test.com?email=[[PII DETECTED_(EMAIL)]]”. This allows the system 100 to alert the end-user/administrator/customer of the PII being collected without storing the specific PII (e.g., in a database, such as database 314 in FIG. 3). In yet other cases, an element of the system 100 (or system 300), such as the root controller module 304, may be configured to operate in a plurality of different modes of operation, further described below in relation to FIG. 3.

FIG. 1 illustrates a system 100 configured for verifying data, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of computing device event capture module 108, data value obtaining module 110, device interaction module 112, data value generating module 114, computing device transmittal module 116, data value verification module 118, data storing module 120, data value storing module 122, sub-loading module 124, document object model (DOM) changing module 126, user notification module 128, information sending module 130, response receiving module 132, difference adding module 134, difference using module 136, response data value verification module 138, a consent detection module 149, and/or other instruction modules.

Computing device event capture module 108 may be configured to capture data associated with a plurality of computing device first events. In some implementations, the plurality of computing device first events may comprise events occurring before the new data values associated with the computing device interaction are generated.

Data value obtaining module 110 may be configured to obtain one or more allowable data values associated with the plurality of computing device first events.

Device interaction module 112 may be configured to interact with the computing device in one or more computing device second events. In some implementations, at least one of the one or more computing device second events may include the first event type. In some non-limiting examples, the device interaction module (or another module of system 100) may check if the computing device second event comprises one or more new data points, checks if the new data points follow “best practices” for the specific technology, check if the computing device second event is associated with a new event type (i.e., if the computing device second event corresponds to an event not previously received by the system 100), check if the computing device second event causes interaction with a new/unknown endpoint, and/or check if the computing device second event did not occur as expected (e.g., checking if the second event did not occur when it should have or vice-versa). By way of non-limiting example, the one or more computing device second events may include passing of a predefined amount of time (e.g., 2 minutes, 10 minutes, an hour, etc.), navigating to a new digital touchpoint, or clicking or interacting with the digital touchpoint, to name a few. Furthermore, in some implementations, one of a website and an application associated with the computing device may include a digital touchpoint. Some other examples of a digital touchpoint include a website or specific URL, mobile app or a specific screen/page in a mobile app, server-side webpage, application or app container page, smart TV application, internet of things (IoT) hosted webpage, server API endpoint, entertainment screen (e.g., airplane screen, smart thermostat, in-car screen, to name a few non-limiting examples), video game console, etc.

Data value generating module 114 may be configured to generate new data values associated with the one or more computing device second events.

Computing device transmittal module 116 may be configured to transmit the new data values from the computing device.

Data value verification module 118 may be configured to verify whether the new data values include at least one of the allowable data values. In some implementations, verifying whether the new data values includes at least one of the allowable data values may comprise running a script on the computing device. In some cases, the script may apply validation rules to the new data values. Furthermore, detecting whether there may be a difference between the new data values and the one or more allowable data values may include conducting at least one of a static and a dynamic analysis of new data values as compared to the allowable data values. In some embodiments, the validation rules may include policies for identifying an event type for the one or more second events. Additionally, or alternatively, the validation rules may include policies for identifying one or more digital touchpoints associated with the one or more second events. In some cases, the validation rules may include policies for determining whether consent has been granted to allow operation of the one or more computing device second events. In some other cases, the validation rules may include policies for determining whether the one or more computing device second events include an allowed event. In some embodiments, the validation rules may include policies for checking whether the new data values include personally identifiable information (PII). By way of non-limiting example, the validation rules may include policies for determining whether the one or more second events are associated with one or more of a unique user, vendor, device, and network.

By way of non-limiting example, the validation rules may be developed from processing the data associated with the plurality of computing device first events, the data received from the data collection server system (e.g., data collection server 310 in FIG. 3), and/or the data stored on the computing device. The plurality of computing device first events may include a first event type and one or more prior events. By way of non-limiting example, the plurality of computing device first events and plurality of computing device second events may include at least one of selecting a feature on one of a website and an application (e.g., mobile app, web app), moving information on a user display to enable the display of new information, entering information onto one of a website and application, providing user consent related to collected information, a network request, a network request response, interactions and/or changes with a document object model (DOM), loading of a domain, and launching of one of an application and an application feature.

Data storing module 120 may be configured to store the data with a data collection server system (e.g., shown as data collection server 310 in FIG. 3) after capturing data associated with the plurality of computing device first events.

Data value storing module 122 may be configured to store the allowable data values with the data collection server system (e.g., data collection server 310) after obtaining one or more allowable data values associated with the plurality of computing device first events. The one or more allowable data values may include data values associated with a response to transmitting the new data values from the computing device.

Data value storing module 122 may be configured to store the new data values with the data collection server system (e.g., data collection server 310) after generating new data values associated with the one or more computing device second events.

In some implementations, processing the data associated with the plurality of computing device first events may include identifying the allowable data values by identifying a digital touchpoint asset associated with the data. Some non-limiting examples of digital touchpoint assets associated with the data may include a mobile application, mobile screen, server-side application, webpage, an HTML code feature in the webpage related to data generation, a computing device displaying the webpage, or an application displaying the webpage. Other types of digital touchpoint assets are contemplated in different embodiments and the examples listed herein are not intended to be limiting. By way of non-limiting example, processing the data associated with the plurality of computing device first events may include identifying the allowable data values by identifying at least one of a visitor, a visit, a web page, and an event associated with the data. In some implementations, processing the data associated with the plurality of computing device first events may include identifying the allowable data values by determining any random data value associated with the data. By way of non-limiting example, processing the data associated with the plurality of computing device first events may include identifying the allowable data values by determining the frequency of and a most frequent value for a particular data point across similar computing device first events, and the entire digital touchpoint. Additionally, or alternatively, processing the data associated with the plurality of computing device first events may include identifying the allowable data values by using the frequency of one or more data points across similar first events and the entire digital touchpoint to determine whether the one or more data points include a required data value or an optional data value. The similar computing device first events may include events where at least a portion of at least one feature associated with the events are the same, further described below.

In some implementations, the at least one feature may include at least one of one or more URL components. By way of non-limiting example, the one or more URL components may include at least one of a protocol, domain, port, path name, query string, hash fragment and data payload, performance information about page load, network request load times, or network request data. By way of non-limiting example, the network request data may include at least one of a protocol, domain, port, path name, query string, hash fragment and data payload, cookie information, JavaScript/JSON variables on the digital touchpoint, one or more values associated with a document object model (DOM) on the digital touchpoint, and one or more event element attributes. By way of non-limiting example, the one or more event element attributes may include at least one of an HTML ID, a class name, XPATH and a text value, a current state of consent values provided by the user, a size and total number of network requests on a page. In some implementations, identifying the allowable data values may further include determining values for the plurality of computing device first events by determining a data type associated with the data. By way of non-limiting example, the data type may include one of a string, number, date, array, and object.

In some embodiments, identifying the allowable data values may further include identifying a data pattern associated with the data type. By way of non-limiting example, the identified data pattern associated with the string may include at least one of a date format, a phone number, an email address, an individual's name, and a credit card number (or any other applicable user-specific financial information, such as a bank account number, a debit card number, etc.). By way of non-limiting example, the data pattern associated with the string may include at least one of a positive number, a negative number, an integer, a floating-point number, and an identified length. By way of non-limiting example, the data pattern associated with the array may include at least one of an array element data type, and a length. The data pattern associated with the object may include one or more sub-variables and one or more types of the one or more sub-variables. Some non-limiting examples of sub-variables and their types, values, and/or existence may include (1) is a variable “pageName” always a string, less than 100 characters in length, and always populated, (2) is a variable “Categories” an array with three string values, and/or (3) is a variable “Timestamp” always a number that is 15 digits long. The data pattern associated with the date may include a specific date range.

Identifying the allowable data values may further include identifying a relationship between different computing device first events by determining whether one or more user actions on the digital touchpoint triggers at least one of the computing device first events. The one or more user actions may include at least one of a timing interval action, and at least one of a network request and a response from the network request. Identifying the allowable data values may further include identifying a relationship between different data. By way of non-limiting example, the relationship between the different data may include sourcing at least part of the different data from at least one of a URL, a JavaScript variable in the DOM, a cookie, one or more digital touchpoint assets (e.g., a web page, an HTML code feature in the webpage related to data generation, a computing device displaying the webpage, or an application displaying the webpage, to name a few), a network request or a response to a network request, HTML elements, device information, location information, timing information, and user input. Detecting whether there may be a difference between the new data values and the allowable data values includes conducting at least one of a static and a dynamic analysis of new data values as compared to the allowable data values. In some examples, static analysis comprises comparing the values found (e.g., new data values) to a list of acceptable static values. As an example, static analysis may comprise evaluating if the value of a variable “home” equals one of “home”, “Home”, or “HOME”. As used herein, dynamic analysis may encompass one or more of pattern matching, fuzzy matching, and using custom logic (e.g., provided by the client/customer, a system administrator, a software developer, etc.) In one non-limiting example, dynamic analysis comprises evaluating if a variable and its associated value (e.g., products:product A) matches the Regular Expression pattern “/\hat{ }products/”. Alternatively, dynamic analysis may comprise evaluating if the value (e.g., product A) of the variable (e.g., product) equals the concatenation of two dynamic values, such as, but not limited to, the value of two query string parameters. By way of non-limiting example, notifying a user of the difference between the new data values and the allowable data values may include providing a notification related to one or more of a percent of total amount of new values experiencing the difference, a percent of new values associated with the digital touchpoint experiencing the difference, or a combination thereof. In some other cases, detecting whether there may be a difference between the new and allowable data values may comprise assessing the new data values with respect to one or more manual rules, where the manual rules are used to define the allowable data values. In some cases, there may be known validations for specific data points from vendors based on pre-defined “best practices”. In one non-limiting example, a lower-case value may always be passed for a data point ‘X’. Alternatively, the length of the value for a variable ‘Y’ should not exceed 20 characters. In such cases, detecting whether there is a difference between the new and allowable data values comprises identifying that both upper- and lower-case characters are being passed for the data point ‘X’, or identifying that the length of the value for the variable ‘Y’ is 25 characters long.

In some implementations, the data value obtaining module 110 may be configured to capture data associated with a plurality of computing device first events. In some implementations, capturing data associated with the plurality of computing device first events may include using the script/code to capture data associated with a plurality of computing device first events. In some implementations, the data value obtaining module 110 (or another module of the system 100) is further configured to send the data to the data collection server system (e.g., data collection server 310 in FIG. 3) to obtain the one or more allowable data values.

Sub-loading module 124 facilitates deployment of a technology type directly on the digital touchpoint and/or enables use of one or more of a “piggy backed” technology and a sub-loaded technology. In some implementations, the sub-loading module is configured to use “piggy backed” or sub-loaded tags for loading one or more trackers/data collectors onto a website, an app, etc. As an example, if a tag ‘A’ is added to a website, where tag ‘A’ loads tags ‘B’, ‘C’, and ‘D’, based on the code in tag ‘A’, and tag ‘D’ further loads tags ‘E’ and ‘F’, then tags ‘B’ through ‘F’ are said to be “piggybacked” or sub-loaded tags.

Document object model changing module 126 (also referred to as DOM changing module 126) may be configured to change the DOM. In some implementations, the computing device event capture module 108 (or another module of system 100, such as device interaction module 112 or data value obtaining module 110) may be configured to identify a relation between different computing device first events by determining whether one or more user actions on the digital touchpoint triggers at least one of the computing device first events, where the one or more user actions comprises at least one of a timing interval action, changing the DOM, a lack of user interaction with the digital touchpoint, a device attribute (e.g., brand/model/make of the computing device, one or more features supported by the computing device, such as, touch screen, Wi-fi, cellular data, screen resolution, color depth, hand-held remote, etc.), a user location, and at least one of a network request and a response from the network request.

User notification module 128 may be configured to notify a user of the difference between the new data values and the allowable data values.

Information sending module 130 may be configured to send information related to the difference to the data collection server system (e.g., shown as data collection server 310 in FIG. 3).

Response receiving module 132 may be configured to receive a response from the user. In some implementations, the response may include a response from a third party. In some implementations, the response may include response data values. In some implementations, the response may identify the difference as one of an acceptable data value and an unacceptable data value.

In some implementations, the allowable data values may include values which enable one or more computing device features. By way of non-limiting example, the one or more computing device features may be associated with one or more of an application installed on the computing device, a website accessed by the computing device, or a server processing environment. In some implementations, the server processing environment may include the computing device and/or an application programming interface (API) utilized by the computing device. In some cases, the script running on the server behaves in a similar or substantially similar manner as the script running on the website, but with a few tweaks. In one non-limiting example, instead of automatically detecting new events (e.g., as done in the client-side approach), information related to the new events may be sent from the computing device event capture module 108 via server-side logic. In some other cases, a unique digital touchpoint hash may have less inputs since users may not be able to interact with the unique digital touchpoint via a graphical user interface (GUI) the same way they can with a web page. In some cases, the data consumed or generated by the API utilized by the computing device may be made available for auditing purposes.

Response receiving module 132 may be configured to receive the response at the computing device.

Difference adding module 134 may be configured to, when the response includes an acceptable data value, add the difference to the stored allowable data values.

Difference using module 136 may be configured to, when the response includes an acceptable data value, use the difference in the stored allowable data values to identify one or more future data values as an allowable data value.

In some implementations, by way of non-limiting example, the number of new values across at least one of an entire digital touchpoint and an identified portion of the digital touchpoint may include the difference, an event type associated with the difference, a network request type associated with the difference, device attributes associated with the difference, and one of a time and a time window associated with the difference. In some implementations, by way of non-limiting example, the difference may include at least one of missing data, malformed data, unanticipated data, and new data. In some cases, the identified portion of the digital touchpoint may include one or more of DOM values, elements (or lack of elements), cookies, local storage on the computing device, JavaScript variables, and/or a portion of the URL. Some portions of the URL may be included, and the remainder excluded, in some examples. For instance, if the URL is “https://www.test.com/pageA.html?test=1&test2=4”, the identified portion may comprise “www.test.com/pageA.html”. Further, some non-limiting examples of DOM elements (i.e., elements contained in the DOM) may include HTML elements and their attributes (e.g., src attribute, style attribute, x-path, id, etc.), JavaScript variables, cookies, local storage, session storage, browser cache, service workers, IndexedDB, other browser storage, push notifications, one or more aspects of the URL (e.g., protocol, domain, port, path, query string, hash), network requests, events triggered from interaction or a lack of interaction with the digital touchpoint, manually triggered events from the digital touchpoint, and/or future browser features made available.

Response data value verification module 138 may be configured to verify whether the response data values include at least one of the allowable data values.

Consent detection module 149 may be configured to determine a current state of consent values provided by the user (e.g., user 351-a in FIG. 3). Additionally, or alternatively, the consent detection module 149 is configured to check if the consent given by the user allows the data (e.g., PII, or any other applicable information) to be captured by the system 100 in the first place. In some examples, the consent detection module 149 captures one or more details of consent related issues (e.g., consent cookie, type of PII found, the data being collected that is violating a consent rule, to name three non-limiting examples) and sends this information for collection. In some embodiments, the consent detection module 149 may also receive the user consent related to collected information and/or user consent specific to an event (e.g., check if the user has granted/denied permission for the event to exist). The consent detection module 149 may work in conjunction with one or more modules of the system 100, such as, but not limited to, the data value verification module 118. As noted above, the data value verification module 118 is configured to use the script to apply validation rules to the new data values, where the validation rules may include policies for determining whether consent has been granted to allow operation of one or more computing device second events, policies for checking whether the new data values include personally identifiable information or PII, etc.

In some implementations, the plurality of computing device first events comprises a first event type and one or more prior events. Further, the one or more computing device second events comprise one or more current events, where the one or more current events may include one or more events later in time as compared to the more or more prior events, and at least one the one or more second events comprises the first event type. It should be noted that, in some examples, any action related to a computing device first event may apply to a computing device second event, and vice-versa, where applicable.

In some implementations, server(s) 102, client computing platform(s) 104, and/or external resources 140 may be operatively linked via one or more electronic communication links. For example, such electronic communication links may be established, at least in part, via a network 150 such as the Internet and/or other networks. It will be appreciated that this is not intended to be limiting, and that the scope of this disclosure includes implementations in which server(s) 102, client computing platform(s) 104, and/or external resources 140 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 140, and/or provide other functionality attributed herein to client computing platform(s) 104. By way of non-limiting example, the given client computing platform 104 may include one or more of a desktop computer, a laptop computer, a handheld computer, a tablet computing platform, a Netbook, a Smartphone, a gaming console, and/or other computing platforms.

External resources 140 may include sources of information outside of system 100, external entities participating with system 100, and/or other resources. In some implementations, some or all of the functionality attributed herein to external resources 140 may be provided by resources included in system 100.

Server(s) 102 may include electronic storage 142, one or more processors 144, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 142 may comprise non-transitory storage media that electronically stores information. The electronic storage media of electronic storage 142 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 142 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 142 may include one or more virtual storage resources (e.g., cloud storage, a virtual private network, and/or other virtual storage resources). Electronic storage 142 may store software algorithms, information determined by processor(s) 144, information received from server(s) 102, information received from client computing platform(s) 104, and/or other information that enables server(s) 102 to function as described herein.

Processor(s) 144 may be configured to provide information processing capabilities in server(s) 102. As such, processor(s) 144 may include one or more of a digital processor, an analog processor, a digital circuit designed to process information, an analog circuit designed to process information, a state machine, and/or other mechanisms for electronically processing information. Although processor(s) 144 is shown in FIG. 1 as a single entity, this is for illustrative purposes only. In some implementations, processor(s) 144 may include a plurality of processing units. These processing units may be physically located within the same device, or processor(s) 144 may represent processing functionality of a plurality of devices operating in coordination. Processor(s) 144 may be configured to execute modules 108, 110, 112, 114, 116, 118, 120, 122, 124, 126, 128, 130, 132, 134, 136, 138, and/or 149, and/or other modules. Processor(s) 144 may be configured to execute modules 108, 110, 112, 114, 116, 118, 120, 122, 124, 126, 128, 130, 132, 134, 136, 138, and/or 149, and/or other modules by software; hardware; firmware; some combination of software, hardware, and/or firmware; and/or other mechanisms for configuring processing capabilities on processor(s) 144. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, 118, 120, 122, 124, 126, 128, 130, 132, 134, 136, 138, and/or 149 are illustrated in FIG. 1 as being implemented within a single processing unit, in implementations in which processor(s) 144 includes multiple processing units, one or more of modules 108, 110, 112, 114, 116, 118, 120, 122, 124, 126, 128, 130, 132, 134, 136, 138, and/or 149 may be implemented remotely from the other modules. The description of the functionality provided by the different modules 108, 110, 112, 114, 116, 118, 120, 122, 124, 126, 128, 130, 132, 134, 136, 138, and/or 149 described below is for illustrative purposes, and is not intended to be limiting, as any of modules 108, 110, 112, 114, 116, 118, 120, 122, 124, 126, 128, 130, 132, 134, 136, 138, and/or 149 may provide more or less functionality than is described. For example, one or more of modules 108, 110, 112, 114, 116, 118, 120, 122, 124, 126, 128, 130, 132, 134, 136, 138, and/or 149 may be eliminated, and some or all of its functionality may be provided by other ones of modules 108, 110, 112, 114, 116, 118, 120, 122, 124, 126, 128, 130, 132, 134, 136, 138, and/or 149. As another example, processor(s) 144 may be configured to execute one or more additional modules that may perform some or all of the functionality attributed below to one of modules 108, 110, 112, 114, 116, 118, 120, 122, 124, 126, 128, 130, 132, 134, 136, 138, and/or 149.

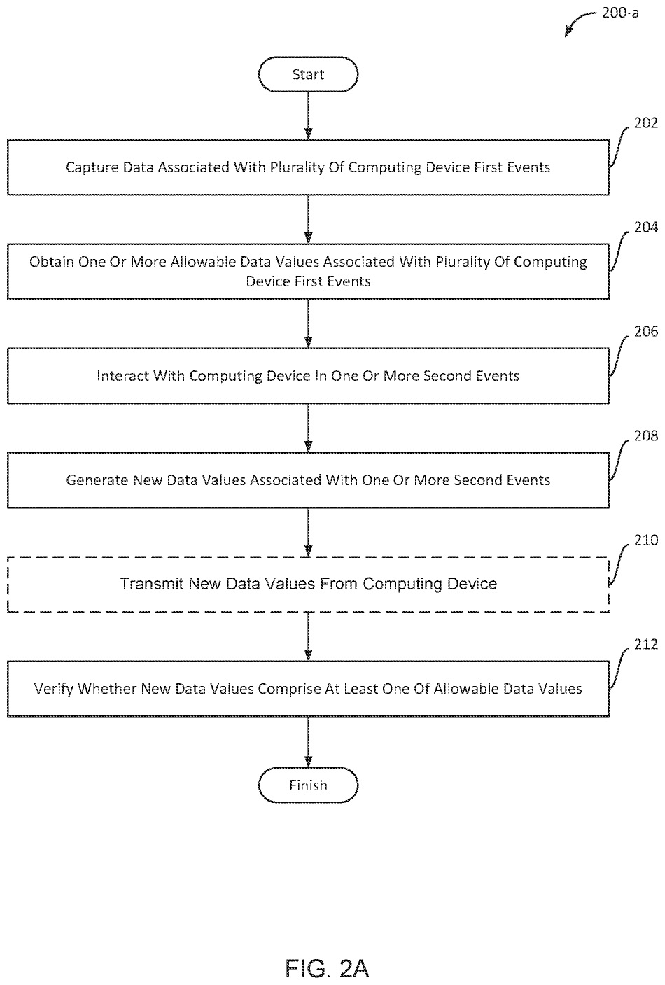

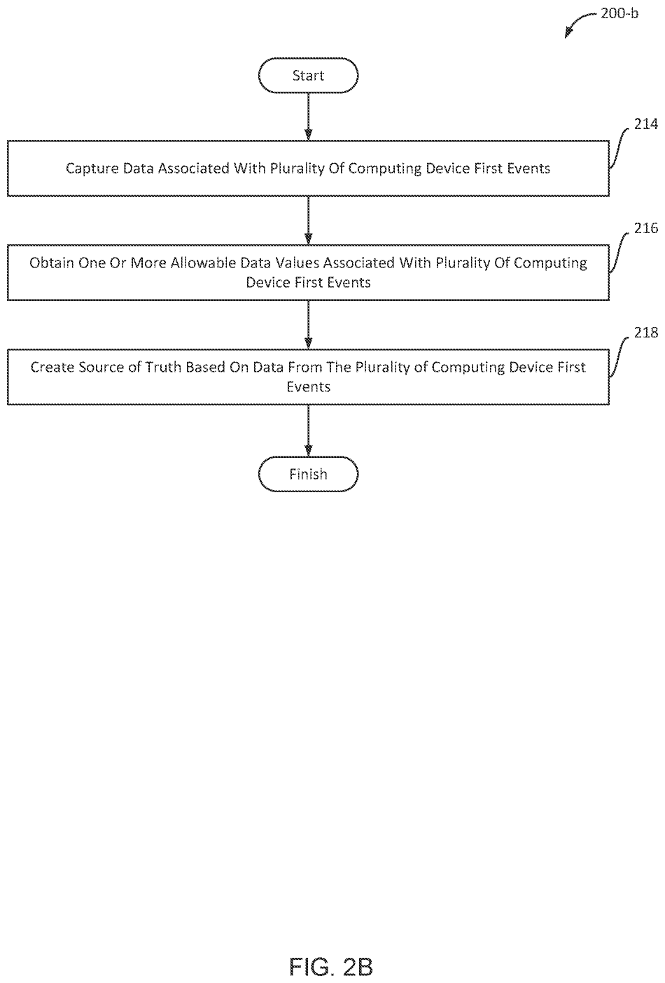

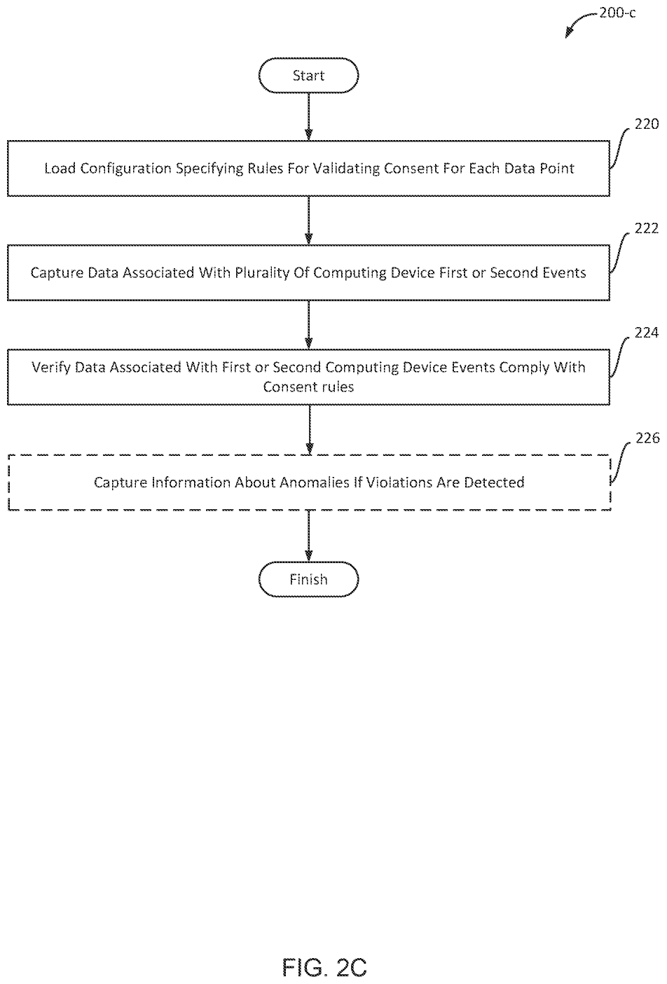

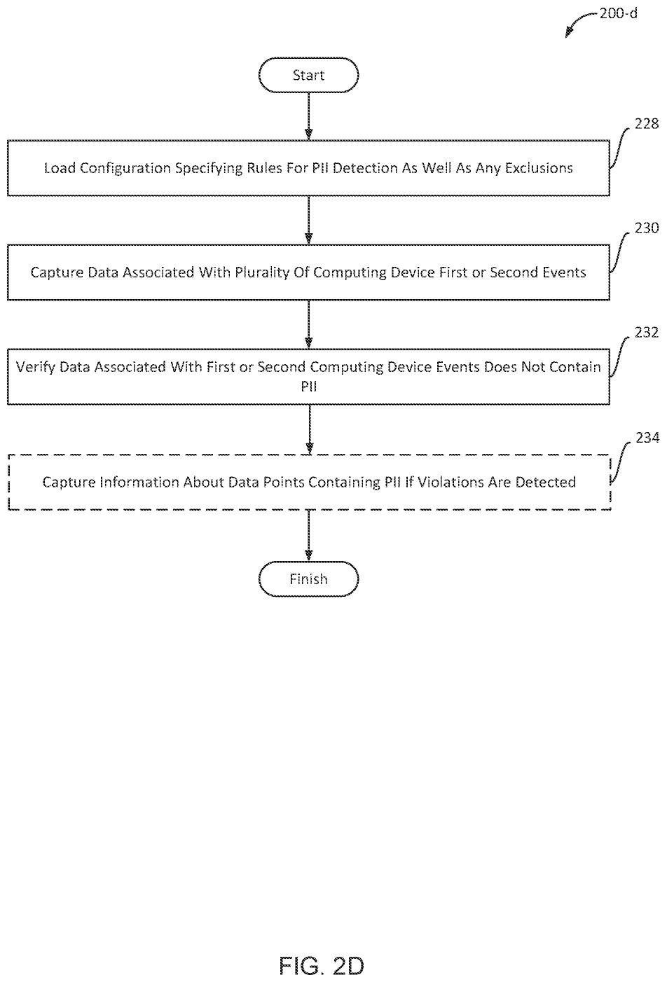

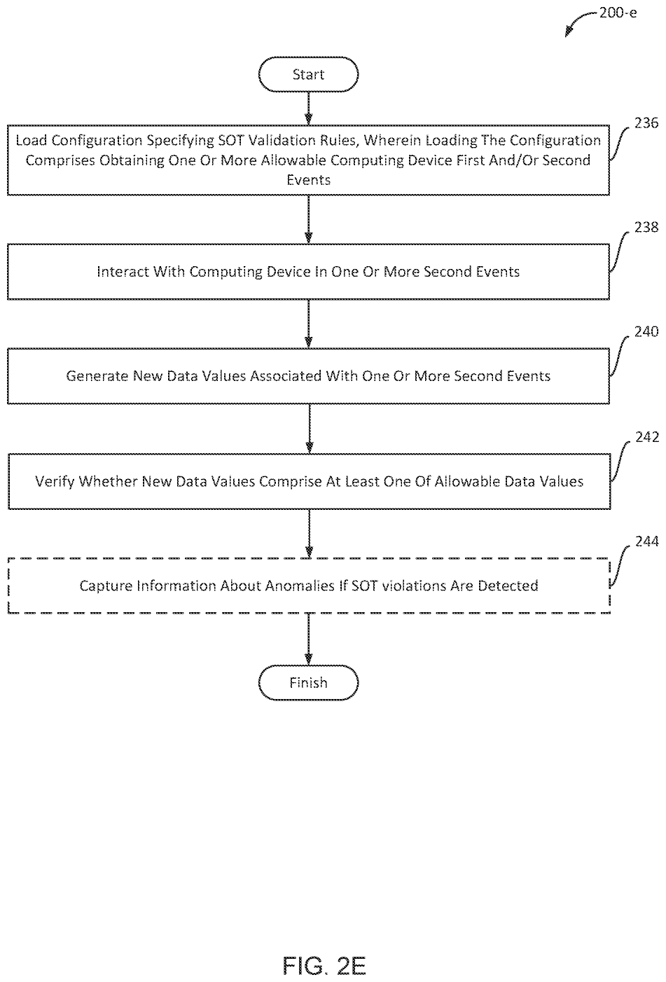

FIGS. 2A-2E illustrates a method 200 (e.g., methods 200-a . . . e) for verifying data, in accordance with one or more implementations. The operations of method(s) 200 presented below are intended to be illustrative. In some implementations, method(s) 200 may be accomplished with one or more additional operations not described, and/or without one or more of the operations discussed. Additionally, the order in which the operations of method(s) 200 are illustrated in FIG. 2 and described below is not intended to be limiting.

In some implementations, method(s) 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method(s) 200 in response to instructions stored electronically on an electronic storage medium. The one or more processing devices may include one or more devices configured through hardware, firmware, and/or software to be specifically designed for execution of one or more of the operations of method(s) 200.

As seen in FIG. 2A, which depicts an example of a method 200-a for verifying data, a first operation 202 may include capturing data associated with a plurality of computing device first events. First operation 202 may be performed by one or more hardware processors configured by machine-readable instructions including a module that is the same as or similar to computing device event capture module 108, in accordance with one or more implementations.

A second operation 204 may include obtaining one or more allowable data values associated with the plurality of computing device first events. Second operation 204 may be performed by one or more hardware processors configured by machine-readable instructions including a module that is the same as or similar to data value obtaining module 110, in accordance with one or more implementations.

A third operation 206 may include interacting with the computing device in one or more second events (also referred to as computing device second events). Third operation 206 may be performed by one or more hardware processors configured by machine-readable instructions including a module that is the same as or similar to device interaction module 112, in accordance with one or more implementations.

A fourth operation 208 may include generating new data values associated with the one or more second events (or computing device second events). Fourth operation 208 may be performed by one or more hardware processors configured by machine-readable instructions including a module that is the same as or similar to data value generating module 114, in accordance with one or more implementations.

A fifth operation 210 (shown as optional by the dashed lines) may include transmitting from the computing device the new data values. This transmitting of the one or more data values (i.e., new data values) from the computing device may be optional, in some examples. In some cases, the one or more data values (e.g., associated with a second event) may be sent external to the root controller module (shown as root controller module 304 in FIG. 3), for instance, when an anomaly/issue is detected in the new data values. In some other cases, the one or more data values may be sent (e.g., prior to checking said data) to an external entity outside the root controller module, for instance, if the data values are collected as part of a server-side data collection operation. Fifth operation 210 may be performed by one or more hardware processors configured by machine-readable instructions including a module that is the same as or similar to computing device transmittal module 116, in accordance with one or more implementations.

A sixth operation 212 may include verifying whether the new data values include at least one of the allowable data values. Sixth operation 212 may be performed by one or more hardware processors configured by machine-readable instructions including a module that is the same as or similar to data value verification module 118, in accordance with one or more implementations.

FIG. 2B illustrates an example of a method 200-b for collecting data, in accordance with one or more implementations. Broadly, the method 200-b outlines how data is initially collected by the system 100, 300. In some aspects, the method 200-b relates to the operation of the script when there is no SOT (e.g., SOT has not yet been created) or when there is no past data (i.e., for verification).

A first operation 214 comprises capturing data associated with a plurality of computing device first events. First operation 214 may be performed by one or more hardware processors configured by machine-readable instructions including a module that is the same as or similar to computing device event capture module 108, in accordance with one or more implementations.

A second operation 216 comprises obtaining one or more allowable data values associated with the plurality of computing device first events. Second operation 216 may be performed by one or more hardware processors configured by machine-readable instructions including a module that is the same as or similar to data value obtaining module 110, in accordance with one or more implementations.

A third operation 218 comprises creating a source of truth (SOT) based on capturing the data associated with the plurality of computing device first events. Third operation 218 may be performed by one or more hardware processors configured by machine-readable instructions including a module that is the same as or similar to the SOT generation module 308, described below in relation to FIG. 3.

FIG. 2C illustrates an example of a method 200-c for consent validation, in accordance with one or more implementations. Broadly, method 200-c outlines the operation of the script when the systems 100, 300 are performing consent validation.

A first operation 220 comprises loading a configuration, where the configuration specifies rules for validating consent for each data point of a plurality of data points. First operation 220 may be performed by one or more hardware processors configured by machine-readable instructions including one or more modules that are the same as or similar to consent detection module 149 and/or rules module 306, in accordance with one or more implementations.

A second operation 222 comprises capturing data associated with a plurality of computing device first events and a plurality of second events. Second operation 222 may be performed by one or more hardware processors configured by machine-readable instructions including a module that is the same as or similar to computing device event capture module 108, in accordance with one or more implementations.

A third operation 224 comprises verifying the data associated with the plurality of computing device first events and/or the plurality of second events comply with consent rules. Third operation 224 may be performed by one or more hardware processors configured by machine-readable instructions including one or more modules that are the same as or similar to consent detection module 149, response data value verification module 138, data value verification module 118, and/or rules module 306, in accordance with one or more implementations.

A fourth operation 226 comprises capturing information about one or more anomalies (if any), for instance, if violations are detected at third operation 224. In some examples, the fourth operation 226 may be optional (shown as optional by the dashed lines). Fourth operation 224 may be performed by one or more hardware processors configured by machine-readable instructions including one or more modules that are the same as or similar to consent detection module 149, response data value verification module 138, difference adding module 134, response receiving module 132, difference using module 136, database 314, alerting server 312, data collection server 310, response server 316, and/or rules module 306, in accordance with one or more implementations.

FIG. 2D illustrates an example of a method 200-d for PII validation, in accordance with one or more implementations. Broadly, method 200-d outlines the operation of the script when the system 100 is checking for PII.

A first operation 228 comprises loading a configuration, where the configuration specifies rules for PII detection and optionally one or more exclusions. First operation 228 may be performed by one or more hardware processors configured by machine-readable instructions including one or more modules that are the same as or similar to consent detection module 149, SOT generation module 308, and/or rules module 306, in accordance with one or more implementations.

A second operation 230 comprises capturing data associated with a plurality of computing device first events and a plurality of second events. Second operation 230 may be performed by one or more hardware processors configured by machine-readable instructions including a module that is the same as or similar to computing device event capture module 108, in accordance with one or more implementations.

A third operation 232 comprises verifying the data associated with the plurality of computing device first events and/or the plurality of second events does not contain PII for one or more users (e.g., user 351-a in FIG. 3). Third operation 232 may be performed by one or more hardware processors configured by machine-readable instructions including one or more modules that are the same as or similar to consent detection module 149, response data value verification module 138, data value verification module 118, SOT generation module 308, and/or rules module 306, in accordance with one or more implementations.

A fourth operation 234 comprises capturing information about one or more data points containing PII, for instance, if one or more violations are detected at third operation 232. As shown by way of the dashed lines, the fourth operation 234 may be optional in some embodiments. Fourth operation 234 may be performed by one or more hardware processors configured by machine-readable instructions including one or more modules that are the same as or similar to consent detection module 149, response data value verification module 138, difference adding module 134, response receiving module 132, difference using module 136, database 314, alerting server 312, data collection server 310, response server 316, and/or rules module 306, in accordance with one or more implementations.

FIG. 2E illustrates an example of a method 200-e for SOT validation, in accordance with one or more implementations. Broadly, method 200-e outlines the operation of the script when a SOT exists and where the SOT is used to validate the data being passed.

A first operation 236 comprises loading a configuration, where the configuration specifies rules for SOT validation (herein referred to as SOT validation rules). In some examples, loading the configuration specifying SOT validation rules comprises obtaining one or more allowable computing device first events and/or second events. First operation 236 may be performed by one or more hardware processors configured by machine-readable instructions including one or more modules that are the same as or similar to computing device event capture module 108, consent detection module 149, SOT generation module 308, and/or rules module 306, in accordance with one or more implementations.

A second operation 238 comprises interacting with the computing device in one or more second events. Second operation 238 may be performed by one or more hardware processors configured by machine-readable instructions including a module that is the same as or similar to device interaction module 112, in accordance with one or more implementations.

A third operation 240 comprises generating new data values associated with the one or more second events (or computing device second events). Third operation 240 may be performed by one or more hardware processors configured by machine-readable instructions including a module that is the same as or similar to data value generating module 114, in accordance with one or more implementations.

A fourth operation 242 comprises verifying whether the new data values include at least one of the allowable data values. Fourth operation 242 may be performed by one or more hardware processors configured by machine-readable instructions including a module that is the same as or similar to data value verification module 118, in accordance with one or more implementations.

A fifth operation 244 comprises capturing information about one or more anomalies (if any), for instance, if SOT violations are detected at fourth operation 242. In some examples, the fifth operation 244 may be optional (shown as optional by the dashed lines). Fourth operation 244 may be performed by one or more hardware processors configured by machine-readable instructions including one or more modules that are the same as or similar to consent detection module 149, response data value verification module 138, difference adding module 134, response receiving module 132, difference using module 136, database 314, alerting server 312, data collection server 310, response server 316, and/or rules module 306, in accordance with one or more implementations.

FIG. 3 illustrates an example of a system 300 configured for verifying data, in accordance with one or more implementations. System 300 may implement one or more aspects of system 100 seen in FIG. 1. In some implementations, system 300 may include one or more servers 310, 316, where server 310 may be referred to as a data collection server 310 and server 316 may be referred to as a reporting server 316. The server(s) 310, 316 may be configured to communicate with one or more client computing platforms 350 (also referred to as user device 350) according to a client/server architecture and/or other architectures. In some examples, the user device 350-a is associated with an end-user (i.e., the user 351-a accessing the digital touchpoint, such as a web page or an app), while the user device 350-b is associated with a client or system administrator, such as user/client 351-b. Further, the servers 310, 316 may implement one or more aspects of the server 102 described in relation to FIG. 1. In some examples, the user device 350 may be similar or substantially similar to the client computing platform(s) 104 also described in relation to FIG. 1. Further, the user device(s) 350 may be configured to communicate with other client computing platforms via one or more other servers (not shown) and/or according to a peer-to-peer architecture and/or other architectures. In some examples, a user 351-a may access system 300 via the client computing platform/user device 350-a. Additionally, a second user 351-b (also referred to as client 351-b) may access the system 300 via the user device 350-b.

The illustration in FIG. 3 also depicts some examples of the data flows 305 occurring between different elements of the system 300. As seen, the system 300 comprises a root controller module 304, rules module 306 (also referred to as dynamically loaded rules module 306), data collection server 310, source of truth (SOT) generation module 308, reporting server 316, and alerting module 312. The system 300 may also comprise one or more of the other modules (e.g., modules 108, 110, 112, 114, 116, 118, 120, 122, 124, 126, 128, 130, 132, 134, 136, 138, and/or 149 in FIG. 1), and the illustration in FIG. 3 is not intended to be limiting.

In some examples, the user devices 350-a, 350-b are associated with the users 351-a, 351-b, respectively, and may be an example of a laptop, smart phone, notebook, etc. The user device 350-a may allow the user 351-a to access a digital touchpoint 302, such as a web page, a mobile or web app, to name two non-limiting examples. Optionally, the digital touchpoint 302 may also display a URL 301 (of the web page) on the display screen of the user device 350-a.

The root controller module 304 is configured to generate root/master controller logic, which can be run/executed on the digital touchpoint 302. Specifically, but without limitation, the master controller logic may be loaded onto a browser, mobile app, or server-side executed code (e.g., JavaScript, Swift, Java, etc.) on the digital touch point 302, as shown by data flow 305-a. This master controller logic is then run inside of the browser, mobile app, or the server-side executed code (e.g., JavaScript, Swift, Java, etc.) on the digital touchpoint 302. In some examples, the root controller module 304 may also listen for (i.e., monitor) events occurring on the digital touchpoint 302, shown by data flow 305-a. Additionally, or alternatively, the root controller module 304 is configured to interact with the rules module 306 to check for anomalies in the data associated with the digital touch point 302. For example, the root controller module 305 receives rules files (e.g., in data flow 305-j from the rules module 306 and/or in data flow 305-k from the SOT generation module 308) and uses these rules files to check for anomalies. As used herein, the term “rules file” may refer to a file containing one or more rules, or rules that are as stored as files. In some instances, the root controller module 305 is further configured to capture event data (e.g., data pertaining to a computing device first event and/or a computing device second event).

The root controller module 304 is configured to detect, collect, audit, and/or send data about events happening on the digital touchpoint 302 to the data collection server 310. In some examples, the root controller module 304 uses the rules files generated from the SOT generation module 308 as a basis for detecting and/or collecting.

The root controller module 304 may be embodied in hardware, software, or a combination thereof. For example, the root controller module 304 may include one or more hardware processors configured by machine-readable instructions to effectuate the operations/methods of a script/code associated with the root controller module 304. The different modes of operation of the script are described below. Although these are listed separately, the script may operate in multiple modes simultaneously, in some examples. In some examples, the root controller module 304 may operate the script/code in a data collection mode and a validation mode, although other types of modes are contemplated in different embodiments. Despite some of the differences between the different modes of operation, described in further detail below, the modes may also have some commonalities. For instance, in some examples, regardless of the mode, the configuration of the script may be dynamically changed by requesting a configuration update from the dynamically loaded rules module (i.e., rules module 306), where the configuration update request may be directly sent to the rules module 306 or sent via a server. The script configuration (i.e., configuration of the script) defines how the script operates and/functions. In such cases, the rules module 306 (or alternatively the server) may change one or more initial settings defined at the initialization of the script. In some other cases, regardless of the mode, the script may halt at least a portion of (or all) operations if a specific setting is enabled. As an example, the script may decide to halt all (or at least a portion of) its operations if a specific configuration variable (e.g., killSwitch) is enabled. In another example, the script may halt its operations if a “fatal” error occurs inside the script. In some cases, user (or administrator) intervention may be needed to resolve this fatal error. It should be noted that, in some examples, the script may be loaded by the root controller module 304 on the web page(s) or application code of the digital touchpoint 302.

In the data collection mode, the root controller module 304 (or the script) listens for new events happening on the digital touchpoint 302, such as, but not limited to, new network requests and their response data, network requests that did not happen (e.g., as expected, or did not happen at all), interactions such as a page loading, mouse clicks, mouse scrolls, touches (e.g., on a touch screen using fingers or a stylus), elapsed time, new cookies set, changes in JavaScript variables, changes in a DOM, identification of one or more errors, changes in the URL 301, console messages, or manually triggered events at the digital touchpoint 302. When these new events happen, the root controller module 304 (or another module of the system 300) captures the data associated with these events (i.e., data about and from these events) and sends it to the data collection server 310 for further processing.

In the validation mode, the root controller module 304 is configured to dynamically download rules (or rules files) from the dynamically loaded rules module 306, as depicted by data flow 305-j. The rules/rules file may include information about the digital touch point 302 currently being viewed. Additionally, or alternatively, the rules file(s) may include validation rules that can be run against one or more detected events (e.g., events happening on the digital touchpoint that may be detected by the root controller module 304). In some cases, these validation rules are stored in memory (e.g., RAM, ROM, DRAM, SRAM, solid-state drive, flash memory, to name a few), local storage, session storage, local database (DB), or any other applicable location on the disk of the user device 350.

In some examples, when a new event is detected, the root controller module 304 (or another module of the system 300) identifies the event type for the new event and checks the validation rules to determine if any existing rules match said event. If a match is found, the root controller module 304 uses the rules to check various aspects of the event to determine if data is missing, new data is found, if existing data elements in the event do not include expected values, or if the state of any aspect (DOM, JS variables, cookies, custom data sent to us, etc.) of the digital touchpoint is not as expected. If any discrepancies are found, details about the discrepancies are collected and sent to the data collection server 310, further described above. In some examples, the root controller module 304 (or another module of system 300) may perform one or more additional actions for each event, where these additional actions may be performed regardless of if a rule match is found for an event. Some non-limiting examples of additional actions taken on each event include checking for personally identifiable information (PII), checking the detected event against an allowed list of events, and/or checking for user consent specific to the event (e.g., check if the user has granted/denied permission for the event to exist). In some examples, consent detection module 149 (previously described in relation to FIG. 1) may be configured to check for user consent specific to the event. If any of these additional actions/checks fail, details of the event are captured and sent to the data collection server 310 for further analysis.

In some embodiments, the script/code discussed above may be directly embedded into the HTML/source code of the digital touchpoint 302. Alternatively, a tag management system (TMS) facilitates in loading the script/code from other code placed on the HTML/source code of the digital touchpoint 302.

The rules module 306 (also referred to as dynamically loaded rules module 306) is configured to store runtime configuration changes and data generated by the SOT generation module 308, which are used to validate one or more second events and network requests on the user device 350-a, for example. In one non-limiting example, the rules module 306 comprises the logic generated by the SOT generation module 308, which is used/accessed by the root controller module 304 to validate one or more second events occurring on the digital touchpoint (e.g., a website). In some instances, the data generated by the SOT generation module may be used to validate one or more second events (i.e., in addition to or in lieu of the network requests), such as, data layer updates, interactions, request responses, etc. In some examples, the rules module 306 also stores rules files, where the rules files comprise dynamically loaded rules. As noted above, the configuration of the script (run on the digital touchpoint 302) may be dynamically changed by requesting a configuration update from the dynamically loaded rules module (i.e., rules module 306). In such cases, the rules module 306 (or another module of the system 100 and/or 300) is configured to change or modify the dynamically loaded rules of the rules files. In some instances, the rules module 306 is configured to dynamically download the rules/rules files based on the logic and configuration at the root controller module 304. As an example, the configuration at the root controller module 304 may dictate (or may be used to determine) that only one rules file may need to be downloaded on the digital touchpoint 302 or the web page. Alternatively, the rules module 306 may determine that more than one rules file needs to be downloaded based on the configuration and various aspects of the digital touchpoint, such as, but not limited to, the URL, DOM values, JavaScript variables, cookie values, browser storage values, etc. In this way, the rules module 306 utilizes the logic and configuration information at the root controller module 304 for determining which rules/rules files should be downloaded, how many rules/rules files should be downloaded, etc. As noted above, in some examples, a configuration file may be downloaded from a remote server for dynamically changing the operation/functionality of the code or script. In some instances, the configuration file may include one or more elements of the SOT for at least a portion of (or all) web pages of the digital touchpoint 302 being viewed by the user 351-a. In some examples, the one or more elements of the SOT comprise the allowable values for all pages of the website, which may be different than the page-specific values that are also downloaded on every page as a user navigates between different pages.

In some examples, the rules file (or another file) may be uniquely tied to the digital touch point 302 (e.g., web page, web site, mobile or web app) being viewed by the user 351-a, where the rules file includes the source of truth (SOT) for the second events and/or the SOT for the various elements (e.g., network requests, DOM elements, JavaScript variables, consent state, browser or device storage mechanisms, etc.) on the digital touch point 302. In some cases, the rules file (or another file) may comprise a file name, where the file name is based in part on the output of a hash, where the hash may be generated from one or more of unique parts of the page URL 301, DOM values, and/or browser attributes, to name a few. In this way, the rules file utilized for analyzing the events happening on a digital touch point may be uniquely tied to the specific digital touchpoint (e.g., digital touch point 302) being viewed by the user 351-a, where the rules file further comprises the SOT for a plurality of elements, such as DOM elements, on that digital touchpoint or page. In some cases, the script uses the data in this rules file to validate if the information within the requests is accurate, and if not, capture anomalies. Some non-limiting examples of DOM elements (i.e., elements contained in the DOM) may include HTML elements and their attributes (e.g., src attribute, style attribute, x-path, id, etc.), JavaScript variables, cookies, local storage, session storage, browser cache, service workers, IndexedDB, other browser storage, push notifications, one or more aspects of the URL (e.g., protocol, domain, port, path, query string, hash), network requests, events triggered from interaction or a lack of interaction with the digital touchpoint, manually triggered events from the digital touchpoint, future browser features made available, etc.

In some embodiments, the logic to uniquely identify the web page, unique digital touchpoint, etc., is stored in the root controller module 304 or the configuration file and is unique to each client. The root controller module 304 serves as the core engine on the client side and finds new events, checks for errors in said events, etc. Further, the root controller module 304 comprises configuration settings that may be changed/modified via the configuration file. While not necessary, the configuration file may comprise (or maybe an example of) a “global.js” file that can be used to update the configuration settings at the root controller module 304 to modify the behavior (e.g., operations, functionality) of the script.

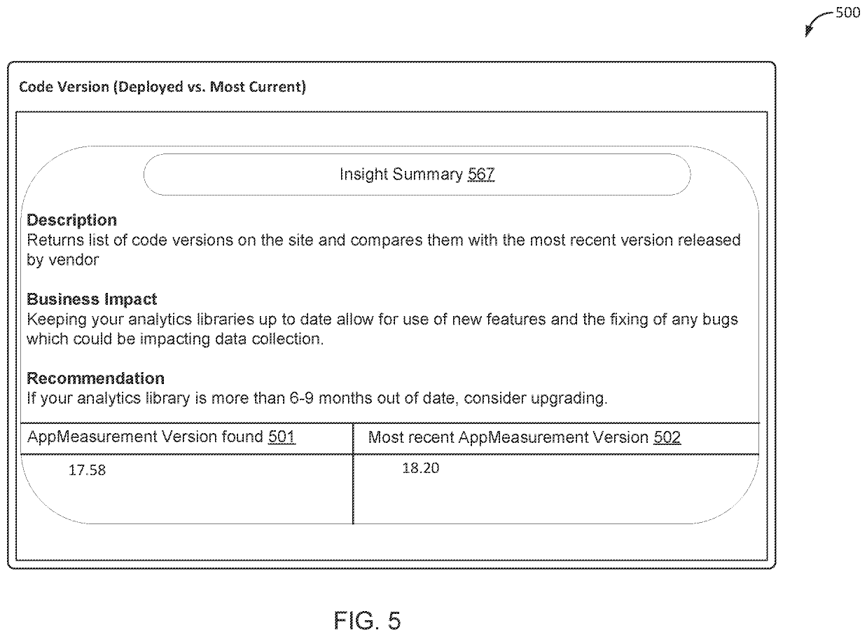

Broadly, data collection server 310 serves as a data collection, processing, and aggregation service in system 300. In some examples, the data collection server 310 is configured to collect the data generated by the root controller module 304, transform the data (e.g., into a different format that is understandable by the database 314, remove duplicate entries, enrich the originally collected data using one or more other data sources and mechanisms, such as geo-location information, IP address, device 350-a manufacturer details, etc., to name a few non-limiting examples), and then load the transformed data into the database 314 via dataflow 305-d. The use of a database is not intended to be limiting, and other data storage mechanisms known and contemplated in the art may be utilized in different embodiments. In some other cases, the data collection server 310 may also identify network requests that are tied to specific technologies. For example, the data collection server 310 may be aware that a request with a URL containing “https://www.googletagmanager.com/gtm.js” is Finked to GOOGLE's Tag Management Technology provided by ALPHABET, INC., of Mountain View, CA. Similarly, the data collection server 310 may be aware that a request with a URL containing “https://www.google-analytics.com/collect?” is linked to GOOGLE ANALYTICS provided by ALPHABET, INC., of Mountain View CA. Thus, the data collection server 310 may be configured to extract, process, transform, and load the incoming data (e.g., received via data flows 305-a and 305-c) from the root controller module 304 into a location such as a database 314, document store, data repository, or data storage system, as shown by data flow 305-d. Once the data is stored, the system 300 (or an element of the system, such as reporting server 316) analyzes the data received by the database 314 and presents it to the client/user 351-b via a user interface of the user device 350-b, further described in relation to FIGS. 5-7.

The system 300 further comprises an alerting module 312, where the alerting module 312 is electronically, logistically, and/or communicatively coupled to the one or more other modules of the system 300 (or system 100), including at least the database 314. The alerting module 312 helps send alerts (or error messages) to the user 351-b (e.g., a system administrator) about data issues or errors identified by the system. In one non-limiting example, the alerting module 312 may receive an instruction to transmit an alert related to data issues (e.g., discrepancies in data associated with the computing device first and/or second events) to a system administrator, where the instruction may be received from the database 314 (or another module of the system, such as root controller module 304, SOT generation module 308) via data flow 305-e. In some examples, the alerting module 312 may send alerts (e.g., shown as data flow 305-k) via SMS or text, email, push notifications on the user device 350-b associated with the user/system administrator 351-b, a webhook, or any other applicable means of digital communication. In some other cases, the alerting module 312 may determine a degree of “severity” of the data issues identified at the digital touchpoint and determine whether human intervention is needed. For example, the alerting module 312 may trigger an alert that is sent to an autonomous system (e.g., computing device 350-b), where the autonomous system then determines an appropriate course of action. That is, it is contemplated that one or more of the data issues may be resolved with minimal to no human intervention, for example, by sending an alert to an autonomous system, as opposed to a human. In some examples, the system 300 may autonomously check to see if the one or more data issues are experienced by the majority (or all) of the users (e.g., >70%, >90%, 100%), or only a small group of users (e.g., <10%, <20%, <5%, etc.). In the latter, the system may autonomously collect one or more details about the user and/or user device (e.g., manufacturer/make/model number/year when device 350-a was released/operating system version/browser or app version/processing capabilities, etc., for the user device 350-a; geo-location information of user/user device when digital touchpoint 302 was accessed, to name a few) and forward it to the user 351-b for further analysis. In other cases, the system 300 may autonomously check where (e.g., a particular web page, such as purchase confirmation page) on the digital touchpoint 302 the issue is occurring. In such cases, the system 300 may assign the data issue as “severe” or “high severity” if the data issue occurs on a purchase confirmation page (e.g., since the confirmation page may be more important to the client from a business standpoint), and “not severe” or “low severity” if the data issue occurs on a “random” category page, such as a page listing the team members/employees at the company, a page listing the white papers published by the company, and/or a page listing the motivation/purpose of the company, to name a few. In yet other cases, the system 300 may autonomously check if the data issue encountered is a known/documented/existing issue, check if there are any fixes or patches to said issue, and take an appropriate action based on these findings. It should be noted that the data flow 305-k may be optional, in some embodiments.

In some examples, the alerts (e.g., in data flow 305-k) transmitted from the alerting module 312 may be customizable by a user (e.g., user 351-b). For example, the alerting module 312 may be configured to transmit an alert based on comparing the percentage of total traffic experiencing the data anomaly to a first threshold, where the threshold is customizable by the user. In other cases, the alerting module 312 may be configured to transmit an alert based on comparing the percentage of traffic going to a specific digital touchpoint (e.g., digital touchpoint 302) experiencing the anomaly to a second customizable threshold. In yet other cases, the alerting module 312 may be configured to transmit alert(s) based on static counts of data anomalies occurring across the digital touchpoint 302 (e.g., transmit an alert if static counts exceed a predefined threshold, where the threshold may or may not be customizable), static counts for specific stats of the digital touchpoint, the event type, the network request type, attributes of user device 350-a, the time or time window, to name a few non-limiting examples. For example, the alerting module 312 may transmit alerts when the event type (e.g., for the first and/or second computing device events on the user device 350-a or digital touchpoint 302) matches the event type for which alerts should be sent.

The system 300 further comprises a reporting server 316 (or reporting module 316), where the reporting server helps generate one or more reports in the reporting interface 318 based on the information received from the database 314. As seen, the reporting server (or module) 316 is configured to receive information from the database 314 via data flow 305-f, where the information is associated with the anomalies/issues identified in the data values associated with the first and/or second computing device events, documentation of the data being collected (e.g., at the digital touch point 302), the source of truth or SOT, and/or configuration information for the root controller module 304, to name a few. In some instances, the user/client 351-b may be able to view, modify, and/or customize the values associated with the SOT across the digital touchpoint 302. Additionally, or alternatively, the information received in the data flow 305-f may also comprise information about “best practices” that are being followed, that are not being followed, etc. After receiving the information (via data flow 305-f), the reporting module 316 creates one or more reports, insights, and documentation based on the data in the database 314 (or data store 314). These reports may be presented in a reporting interface 318 on the user device 350-b. In some examples, the report may show anomalies in the data, best practices that are and are not being followed, documentation of the data being collected, the SOT, and/or the configuration of the root controller module 304. Other types of information may be included in the reports generated by the system 300 and the examples listed above are not intended to be limiting.

Some non-limiting examples of “best practices” include (1) verifying that data values do not exceed the character limit, (2) checking if data values are formatted in the correct syntax, (3) checking the number of leading/trailing spaces in data values, (4) checking if any incorrect delimiter has been used, (5) checking if any incorrect value types are used (e.g., value is a string when it should have been a number), (6) checking if the version of the code library is up to date (i.e., is the version of the code library different from the most recent version), (7) checking if the number of account IDs is valid (e.g., a single account ID should be used, as opposed to multiple account IDs), and/or (8) checking if case insensitive values are being used when a single case is more appropriate.

As noted above, the system 300 of the present disclosure supports the reconfiguration of the root controller module 304. For example, users may change/update one or more configuration variables stored in (or associated with) the root controller module 304 to effectuate a change in the configuration of the root controller module. The system 300 may provide an interface (e.g., a user interface or UI, an application programming interface or API) from which the user can change/update the configuration variables.

As seen, the reporting interface 318 (presented on the user device 350-b) serves as a location for the client/user 351-b to view reports, insights, and/or anomalies about the data being collected at (or with regards to) the digital touchpoint 302. In the example shown, the reporting interface 318 displays a line graph, although any other types of reports, graphs, charts, etc., are contemplated in different embodiments. In some cases, the reporting interface 318 (or user device 350-b) receives the data pertaining to the reports, insights, etc., from the reporting module 316 via data flow 305-g. The reporting interface 318 may also allow the user 351-b to view/download the root controller module 304 configuration information. In some implementations, the reporting interface 318 (or another module of the system 300) is configured to generate and export any applicable documentation, data, and/or files associated with the digital touchpoint 302.

Thus, the reporting interface 318 is used to display the reports, insights, and/or documentation generated by the reporting module 316 to the client/end customer/user 351-b. In some examples, the reporting interface 318 also enables the user 351-b to view and optionally change the configuration of the root controller module 304.

The source of truth (SOT) generation module 308 (also referred to as SOT generator 308) comprises one or more algorithms that are designed to determine the correct values for each data point of a network request, DOM state, JavaScript variable, etc. In some examples, the SOT generator 308 may be embodied in hardware, software, or a combination thereof. Further, SOT generator 308 is electronically, logistically, and/or communicatively coupled to the database 314 and one or more other modules and servers (e.g., root controller module 304, rules module 306, data collection server 310) of the system 300. The SOT generator 308 may receive (via data flow 305-h) from the database 314, the data collected by the root controller module 304 and stored by the data collection server 310 in the database 314. The SOT generator 308 interprets the data received in data flow 305-h, creates the data pertaining to the rules (herein referred to as rules-specific data), based upon the interpretation, and relays the rules-specific data to the rules module 306 in dataflow 305-i. The rules module 306 uses this data to generate the rules (e.g., validation rules) used by the root controller module. Alternatively, the SOT generator 308 directly generates the rules and forwards said rules to one or more of the root controller module 304 and the rules module 306 via data flows 305-k and 305-i, respectively. In either case, the root controller module 304 uses the rules/rules-specific data to validate the data being collected on the digital touchpoint 302.

### Operation

Below is described an example method of operation of the present disclosure. This is in no way intended to be limiting and some of the operations may be optional (e.g., based on use case). Additionally, other operations are contemplated in different embodiments and the list of operations discussed herein should not be considered as an exhaustive list. It should also be noted that the operations described below are not limited to the order in which they are listed. For example, some of the operations may take place in parallel or out of order in which they are listed below.

In some cases, the system 300 (or a module of the system, such as root controller module 304, data collection server/module 310, or any of the modules described in relation to FIG. 1) may identify one or more “unique” digital touchpoint 302 assets, such as, a webpage or URL. In this context, “unique” implies that the digital touchpoint 302 asset is associated with a distinct URL, network address, IP address, unique identifier, mobile app screen, server-side URL, etc., that separates it from other webpages (e.g., on the same or different domain, associated with the same or a different website). In some instances, the system 300 may group the digital touchpoint assets based on any combination of attributes collected about/in relation to the digital touchpoint 302, events (e.g., computing device first/second events) captured on the digital touchpoint 302, etc. As noted above, some non-limiting examples of digital touchpoint assets include a webpage, an HTML code feature in the webpage related to data generation, a computing device displaying the webpage, or an application displaying the webpage. Additionally, some non-limiting examples of the attributes and/or events information captured for the digital touchpoint 302 include: (1) URL components (e.g., protocol, domain, port, path name, query string, hash fragment, data payloads sent, data payloads returned, etc.), (2) performance information about page load as well as network request load times, (3) network request data (e.g., protocol, domain, port, path name, query string, hash fragment, data payloads sent, data payloads returned, etc.), (4) cookie names and/or values, (5) JavaScript/JSON variables on the digital touchpoint 302, (6) values pulled from the DOM on the digital touchpoint, (7) event element attributes (e.g., HTML ID, class name, XPath, text value, etc.), (8) current state of consent values provided by the user, (9) the size and/or total number of network requests on a page, (10) if the system 300 (or root controller module 304) was deployed directly on the digital touchpoint 302, or through any number of piggy backed/sub-loaded technologies.

Once the system 300 groups the web pages per digital touchpoint 302, the SOT generator 308 uses one or more algorithms for analyzing one or more data points associated with one or more events (e.g., computing device first and second events) to determine correct values for each of the one or more data points. Some non-limiting examples of data points contained within events include one or more of: URL components (protocol, domain, port, path name, query string, hash fragment, data payloads sent, data payloads returned, etc.); performance information about page load as well as network request load times; network request data (protocol, domain, port, path name, query string, hash fragment, data payloads sent, data payloads returned, etc.); cookie names and/or values; JavaScript or JSON variables on the digital touchpoint; values pulled from the DOM on the digital touchpoint; event element attributes (HTML ID, class name, XPath, text value, etc.); current state of consent values provided by the user; size and total number of network requests on a page; information on whether the technology was directly deployed on the digital touchpoint, or through any number of piggy backed/sub-loaded technologies. In some examples, the analyzing the one or more data points associated with the one or more events comprises one or more of (1) determining the data type (e.g., string, number, date, array, object, null, undefined, regular expression, specific prototype, Boolean, etc.); (2) identifying one or more data patterns, such as, but not limited to, strings, numbers, arrays, objects, dates, mailing address, price or value, social security number or SSN, etc.; (3) determining if the data values are event random (e.g., independent of the event type) or are unique to a visitor/user, a visit or session, a web page, an event; (4) determining how often a data point is populated across all similar event types and different web pages across the digital touchpoint 302; (5) determining the most frequent value(s) for the data point, may be evaluated for all similar event types and different web pages across the digital touchpoint 302; (6) determining if a data value is required or optional based on how often the data value is populated across similar event types and/or different web pages across the digital touchpoint; (7) identifying relationships between different computing device events; and (8) identifying relationships between different data points.

Some non-limiting examples of data patterns for strings include date formats (e.g., YYYY-MM-DD), phone numbers, email addresses, first/last names, and/or credit card information (e.g., credit card number, CVV code, expiration date) or any other applicable financial related information (e.g., checking/savings bank account number, routing number). Some non-limiting examples of data patterns for numbers include positive, negative, integer, floating point, and/or length (e.g., number of significant digits, number of decimal places, to name a few). Some non-limiting examples of data patterns for arrays include data types within each element of an array and/or length of an array. Some non-limiting examples of data patterns for objects include sub-variables and their types (e.g., is variable ‘pageName’ always a string, less than 100 characters in length, and always populated; is variable ‘categories’ an array with three string values; is variable ‘timestamp’ always a number that is 15 digits long, to name a few non-limiting examples of sub-variables and their types, values, and existence). Some non-limiting examples of data patterns for dates include specific date ranges. It should be appreciated that the data patterns described above are not intended to be limiting and other types of data patterns are contemplated in different embodiments. In some cases, identification of such data patterns may facilitate in analyzing the one or more data points associated with the one or more events, such as, but not limited to, the computing device first event or the computing device second event.

In some cases, identifying relationships between different events includes identifying (1) if a specific set of user actions on the digital touchpoint triggers a specific event, (2) if an event is triggered by timing intervals, (3) if an event is triggered by requests or responses from network requests, (4) if an event is triggered by changes in the DOM, (5) if an event is triggered by a lack of user interaction with the digital touchpoint, (6) if an event is triggered by a user device 350-a attribute, (7) if an event is triggered based on the location of user 351-a, to name a few non-limiting examples.

In some cases, identifying relationships between different data points includes identifying (1) if all or part of the data value is sourced from a URL, (2) if all or part of the data value is sourced from a JavaScript variable in the DOM, (3) if all or part of the data value is sourced from a cookie, (4) if all or a part of the data value is sourced from a digital touchpoint 302 asset, (5) if all or part of the data value is sourced from a request, (6) if all or part of the data value is sourced from response data corresponding to a network request, (7) if all or part of the data value is sourced from HTML elements, (8) if all or part of the data value is sourced from information associated with the user device 350-a, (9) if all or part of the data value is sourced from location information (e.g., location of user 351-a, location of user device 350-a), (10) if all or part of the data value is sourced from timing information, (11) if all or part of the data value is sourced from input received from the user 351-a, and/or (12) if all or part of the data values are sourced in combination with any of the sources described in (1)-(12) above.

In some embodiments, the actual consent given by the user 351-a may be stored in the DOM/cookie/variable/browser storage for the digital touchpoint 302. In some examples, the consent given by the user 351-a may be stored in a cookie on the user device 350-a. Further, the stored consent/cookie may be associated with one or more values, where at least one consent value may include the consent state (i.e., state of consent) for one or more technology categories (e.g., analytics, retargeting, personalization, display, etc.). As an example, the consent provided by the user 351-a and stored in a cookie may be represented as: “marketing=true|personalization=false|retargeting=true”. Further, the SOT generator 308 may determine the consent rule and relay it to one or more of the root controller module 304 and the rules module 306. The consent rule may or may not be a part of the source of truth. For example, the consent rule may be a part of the script configuration, where the script configuration may or may not be derived from the source of truth. In some cases, if the script configuration is not derived from the source of truth, consent validation may be performed independent of the source of truth. As described above, the script configuration may be based on the configuration variables/settings indicated by the user 351 (e.g., user 351-b), e.g., via the tag management system or TMS.

Thus, as described above, the outputs of the algorithm(s) executed by the various modules/servers of the system 300, such as, the data collection server 310, the SOT generator 308, the root controller module 304, etc., are stored in a data store (e.g., database 314) and converted into rules served by the rules module 306 (i.e., the dynamically loaded rules module 306), where the root controller module 304 uses these rules to detect anomalies in the data associated with the plurality of computing device first and/or second events. In some examples, the plurality of computing device first and/or second events may be associated with one or more digital touchpoint(s) 302. Further, the computing device first and second events may be associated with the same or a different digital touchpoint, the same or a different computing device, etc.

In some aspects, the illustration in FIG. 3 also depicts a process flow, where the data flows 305 represent the operations of the process flow. For example, a first operation (data flow 305-a) comprises loading the root controller module 304 on a client digital touchpoint 302. A second operation (data flows 305-b, 305-j) comprises downloading, by the root controller module 304, one or more rule files, where the rule files may be used to change the operation of the root controller module 304 and/or add validation rules for the root controller module 304 to use. A third operation (data flow 305-c) comprises collecting, by the data collection server 310, data about events happening at the digital touchpoint 302 and/or data about any anomalies detected by the root controller module 304. A fourth operation (data flow 305-d) comprises processing the collected data and storing it in the database 314. A fifth operation (data flows 305-e, 305-k), which may be optional, comprises using the alerting module 312 to determine if alerts need to be sent (e.g., to the user device 350-b, to the user 351-b). In some cases, the alerting module 312 may be utilized in conjunction with the database 314 (or data store) for performing the fifth operation. A sixth operation (data flows 305-f and 305-g) comprises generating one or more reports and displaying them in the reporting interface 318 on the user device 350-b, where the reports are generated by the reporting server/module 316 and based on the data stored in the database 314. A seventh operation (data flow 305-h) comprises using the data in the database 314 to build out a SOT, where the SOT is generated by the SOT generator 308. An eighth operation (dataflow 305-i) comprises using the SOT generator 308 for creating and/or updating one or more rule files in the rules module 306.

In some examples, the operations described above may be repeated one or more times (or constantly), which helps ensure that the most recent data is being used for generating the source of truth, the rule files, etc. In some circumstances, the rule files may impact the anomalies collected by the system 300, how the anomalies are collected, etc. In such cases, the rule files may be updated over time by way of the operations discussed above.

Turning now to FIGS. 5-7, which illustrate example reports 500-700, respectively, generated by a reporting server/module (e.g., reporting server 316) and presented for display on a user device (e.g., user device 350-a in FIG. 3), according to various aspects of the disclosure.

FIG. 5 illustrates an example of a report 500 that may be generated and displayed via a reporting interface (e.g., shown as reporting interface 316 in FIG. 3), according to various aspects of the disclosure. In this example, the report 500 provides an insight summary 567, where the insight summary includes a description, the potential business impact, and a recommendation for the customer/end-user. Specifically, report 500 is generated after comparing the currently deployed version of an application to the most recent/up to date version of the application available for use. Here, the report 500 displays the Code Version found 501 (e.g., 17.58) and the most recent Code Version 502 (e.g., 18.20). As seen, the system (e.g., system 100, 300) has determined that the Code Version found 501 (i.e., 17.58) and utilized by the end-user is not the most recent version and is recommending the user to upgrade their analytics library based on this finding.

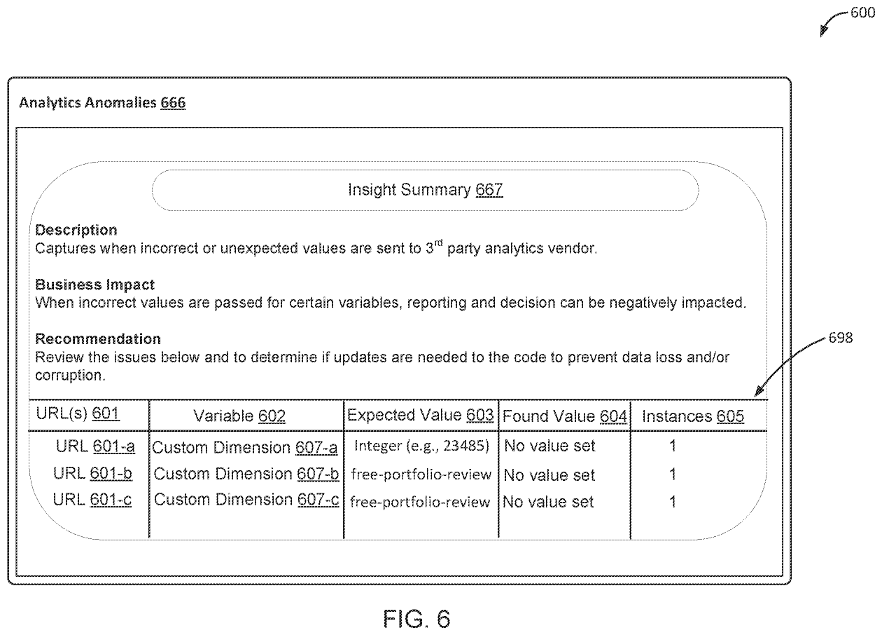

FIG. 6 illustrates an example of a report 600 that is directed to analytics anomalies 666, according to various aspects of the disclosure. In some cases, the report 600 may be used to highlight when incorrect or unexpected values are sent, for example, to a 3^{rd} party analytics vendor. Similar to FIG. 5, the report 600 comprises an insight summary 667, the insight summary 667 including a description of the report 600, business impact, and a recommendation for the end-user. The report further includes a table 698, the table 698 including a plurality of columns (e.g., URL(s) 601, variable 602, expected value 603, found value 604, and instances 605) and a plurality of rows. As seen, the report 600 includes the variable (e.g., custom dimension 607-a, 607-b, or 607-c), the expected value (e.g., integer, free-portfolio-review), the found value (e.g., no value set), and the number of instances (e.g., 1) for each URL (e.g., URL 601-a, 601-b, 601-c). Some non-limiting examples of variables 602 may include page name, page category, and/or a custom dimension. Some non-limiting examples of expected values 603 (i.e., the values expected for a corresponding variable 602 based on the SOT) may include: “home” or “products:phones”. Some non-limiting examples of found values 604 (e.g., the values that did not align with the SOT) may include: “home” or “products|phones”.

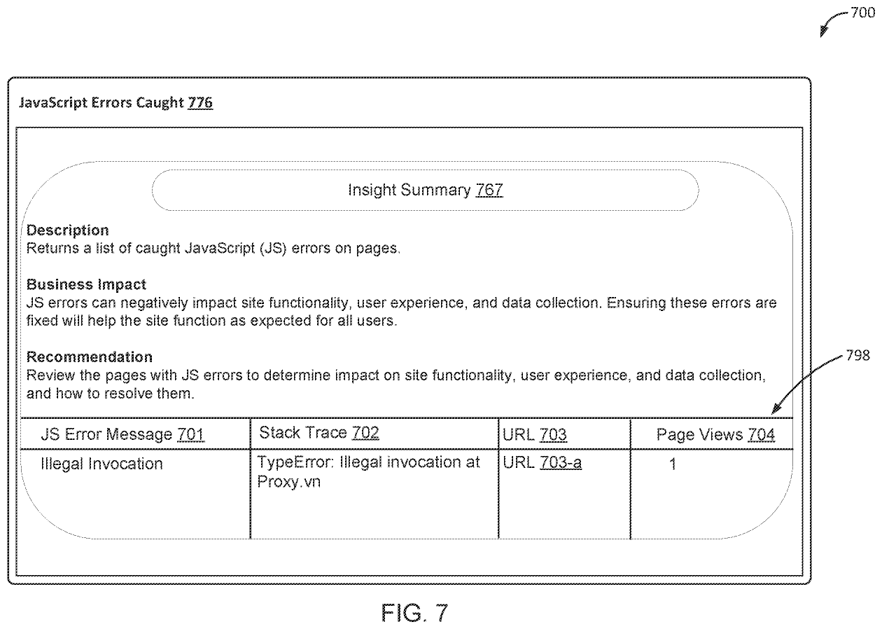

FIG. 7 illustrates an example of a report 700 that may be used for conveying information related to the JavaScript errors caught 776 by the system (e.g., system 100, system 300), according to various aspects of the disclosure. The report 700 includes an insight summary 767, which may be similar or substantially similar to the insight summaries 567 and/or 676 described in relation to FIGS. 5 and/or 6. The report 700 further includes a table 798, the table 798 including a plurality of columns (e.g., JS error message 701, stack trace 702, URL 703, page views 704) and one or more rows. In this example, the table 798 includes the stack trace 702 (e.g., TypeError: Illegal invocation at proxy.vn), the URL 703 (e.g., URL 703-a), and the number of page views 704 (e.g., 1) for each JS error message.

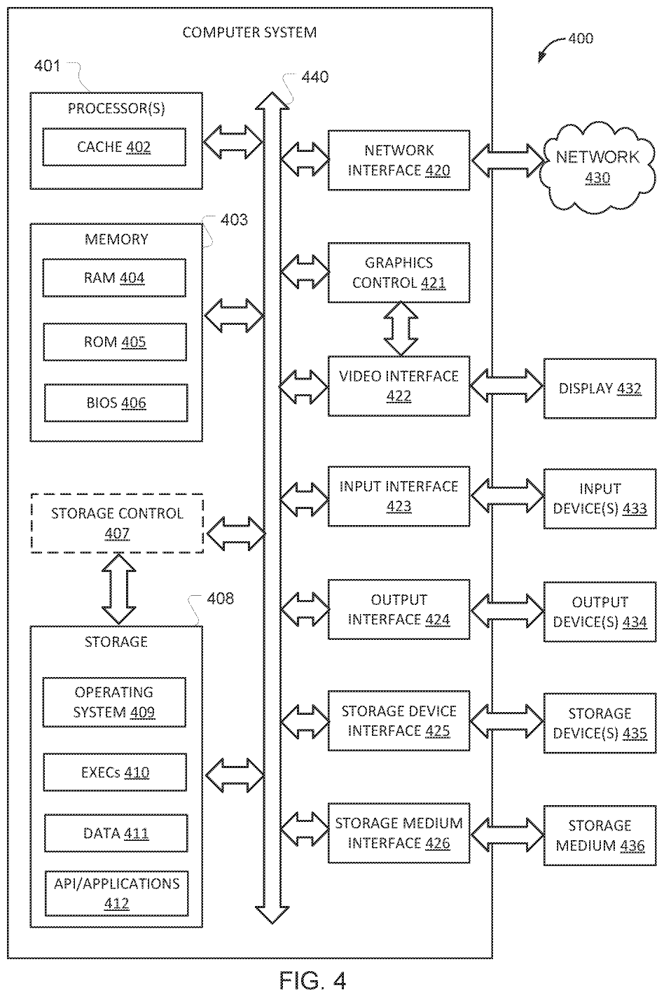

FIG. 4 illustrates a diagrammatic representation of one embodiment of a computer system 400, within which a set of instructions can execute for causing a device to perform or execute any one or more of the aspects and/or methodologies of the present disclosure. The components in FIG. 4 are examples only and do not limit the scope of use or functionality of any hardware, software, firmware, embedded logic component, or a combination of two or more such components implementing particular embodiments of this disclosure. Some or all of the illustrated components can be part of the computer system 400. For instance, the computer system 400 can be a general-purpose computer (e.g., a laptop computer) or an embedded logic device (e.g., an FPGA), to name just two non-limiting examples.

Moreover, the components may be realized by hardware, firmware, software or a combination thereof. Those of ordinary skill in the art in view of this disclosure will recognize that if implemented in software or firmware, the depicted functional components may be implemented with processor-executable code that is stored in a non-transitory, processor-readable medium such as non-volatile memory. In addition, those of ordinary skill in the art will recognize that hardware such as field programmable gate arrays (FPGAs) may be utilized to implement one or more of the constructs depicted herein.

Computer system 400 includes at least a processor 401 such as a central processing unit (CPU) or a graphics processing unit (GPU) to name two non-limiting examples. Any of the subsystems described throughout this disclosure could embody the processor 401. The computer system 400 may also comprise a memory 403 and a storage 408, both communicating with each other, and with other components, via a bus 4100. The bus 4100 may also link a display 432, one or more input devices 433 (which may, for example, include a keypad, a keyboard, a mouse, a stylus, etc.), one or more output devices 434, one or more storage devices 435, and various non-transitory, tangible computer-readable storage media 436 with each other and/or with one or more of the processor 401, the memory 403, and the storage 408. All of these elements may interface directly or via one or more interfaces or adaptors to the bus 4100. For instance, the various non-transitory, tangible computer-readable storage media 436 can interface with the bus 4100 via storage medium interface 426. Computer system 400 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Processor(s) 401 (or central processing unit(s) (CPU(s))) optionally contains a cache memory unit 432 for temporary local storage of instructions, data, or computer addresses. Processor(s) 401 are configured to assist in execution of computer-readable instructions stored on at least one non-transitory, tangible computer-readable storage medium. Computer system 400 may provide functionality as a result of the processor(s) 401 executing software embodied in one or more non-transitory, tangible computer-readable storage media, such as memory 403, storage 408, storage devices 435, and/or storage medium 436 (e.g., read only memory (ROM)). Memory 403 may read the software from one or more other non-transitory, tangible computer-readable storage media (such as mass storage device(s) 435, 436) or from one or more other sources through a suitable interface, such as network interface 420. Any of the subsystems herein disclosed could include a network interface such as the network interface 420. The software may cause processor(s) 401 to carry out one or more processes or one or more steps of one or more processes described or illustrated herein. Carrying out such processes or steps may include defining data structures stored in memory 403 and modifying the data structures as directed by the software. In some embodiments, an FPGA can store instructions for carrying out functionality as described in this disclosure. In other embodiments, firmware includes instructions for carrying out functionality as described in this disclosure.

The memory 403 may include various components (e.g., non-transitory, tangible computer-readable storage media) including, but not limited to, a random-access memory component (e.g., RAM 404) (e.g., a static RAM “SRAM”, a dynamic RAM “DRAM, etc.), a read-only component (e.g., ROM 404), and any combinations thereof. ROM 404 may act to communicate data and instructions unidirectionally to processor(s) 401, and RAM 404 may act to communicate data and instructions bidirectionally with processor(s) 401. ROM 404 and RAM 404 may include any suitable non-transitory, tangible computer-readable storage media. In some instances, ROM 404 and RAM 404 include non-transitory, tangible computer-readable storage media for carrying out a method, such as method 200 described in relation to FIG. 2. In one example, a basic input/output system 406 (BIOS), including basic routines that help to transfer information between elements within computer system 400, such as during start-up, may be stored in the memory 403.

Fixed storage 408 is connected bi-directionally to processor(s) 401, optionally through storage control unit 407. Fixed storage 408 provides additional data storage capacity and may also include any suitable non-transitory, tangible computer-readable media described herein. Storage 408 may be used to store operating system 404, EXECs 410 (executables), data 411, API applications 412 (application programs), and the like. Often, although not always, storage 408 is a secondary storage medium (such as a hard disk) that is slower than primary storage (e.g., memory 403). Storage 408 can also include an optical disk drive, a solid-state memory device (e.g., flash-based systems), or a combination of any of the above. Information in storage 408 may, in appropriate cases, be incorporated as virtual memory in memory 403.

In one example, storage device(s) 435 may be removably interfaced with computer system 400 (e.g., via an external port connector (not shown)) via a storage device interface 425. Particularly, storage device(s) 435 and an associated machine-readable medium may provide nonvolatile and/or volatile storage of machine-readable instructions, data structures, program modules, and/or other data for the computer system 400. In one example, software may reside, completely or partially, within a machine-readable medium on storage device(s) 435. In another example, software may reside, completely or partially, within processor(s) 401.

Bus 440 connects a wide variety of subsystems. Herein, reference to a bus may encompass one or more digital signal lines serving a common function, where appropriate. Bus 440 may be any of several types of bus structures including, but not limited to, a memory bus, a memory controller, a peripheral bus, a local bus, and any combinations thereof, using any of a variety of bus architectures. As an example, and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 400 may also include an input device 433. In one example, a user of computer system 400 may enter commands and/or other information into computer system 400 via input device(s) 433. Examples of an input device(s) 433 include, but are not limited to, an alpha-numeric input device (e.g., a keyboard), a pointing device (e.g., a mouse or touchpad), a touchpad, a touch screen and/or a stylus in combination with a touch screen, a joystick, a gamepad, an audio input device (e.g., a microphone, a voice response system, etc.), an optical scanner, a video or still image capture device (e.g., a camera), and any combinations thereof. Input device(s) 433 may be interfaced to bus 440 via any of a variety of input interfaces 423 (e.g., input interface 423) including, but not limited to, serial, parallel, game port, USB, FIREWIRE, THUNDERBOLT, or any combination of the above.

In particular embodiments, when computer system 400 is connected to network 430, computer system 400 may communicate with other devices, such as mobile devices and enterprise systems, connected to network 430. Communications to and from computer system 400 may be sent through network interface 420. For example, network interface 420 may receive incoming communications (such as requests or responses from other devices) in the form of one or more packets (such as Internet Protocol (IP) packets) from network 430, and computer system 400 may store the incoming communications in memory 403 for processing. Computer system 400 may similarly store outgoing communications (such as requests or responses to other devices) in the form of one or more packets in memory 403 and communicated to network 430 from network interface 420. Processor(s) 401 may access these communication packets stored in memory 403 for processing.

Examples of the network interface 420 include, but are not limited to, a network interface card, a modem, and any combination thereof. Examples of a network 430 or network segment 430 include, but are not limited to, a wide area network (WAN) (e.g., the Internet, an enterprise network), a local area network (LAN) (e.g., a network associated with an office, a building, a campus or other relatively small geographic space), a telephone network, a direct connection between two computing devices, and any combinations thereof. A network, such as network 430, may employ a wired and/or a wireless mode of communication. In general, any network topology may be used.

Information and data can be displayed through a display 432. Examples of a display 432 include, but are not limited to, a liquid crystal display (LCD), an organic liquid crystal display (OLED), a cathode ray tube (CRT), a plasma display, and any combinations thereof. The display 432 can interface to the processor(s) 401, memory 403, and fixed storage 408, as well as other devices, such as input device(s) 433, via the bus 440. The display 432 is linked to the bus 440 via a video interface 422, and transport of data between the display 432 and the bus 440 can be controlled via the graphics control 421.

In addition to a display 432, computer system 400 may include one or more other peripheral output devices 434 including, but not limited to, an audio speaker, a printer, and any combinations thereof. Such peripheral output devices may be connected to the bus 440 via an output interface 424. Examples of an output interface 424 include, but are not limited to, a serial port, a parallel connection, a USB port, a FIREWIRE port, a THUNDERBOLT port, and any combinations thereof.

In addition, or as an alternative, computer system 400 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a non-transitory, tangible computer-readable medium may encompass a circuit (such as an IC) storing software for execution, a circuit embodying logic for execution, or both, where appropriate. The present disclosure encompasses any suitable combination of hardware, software, or both.

Those of skill in the art will understand that information and signals may be represented using any of a variety of different technologies and techniques. Those of skill will further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein, including at least operations 202 through 212 of method 200 in FIG. 2, may be embodied directly in hardware, in a software module executed by a processor, a software module implemented as digital logic devices, or in a combination of these. A software module may reside in RAM memory, flash memory, ROM memory, EPROM memory, EEPROM memory, registers, hard disk, a removable disk, a CD-ROM, or any other form of non-transitory, tangible computer-readable storage medium known in the art. An exemplary non-transitory, tangible computer-readable storage medium is coupled to the processor such that the processor can read information from, and write information to, the non-transitory, tangible computer-readable storage medium. In the alternative, the non-transitory, tangible computer-readable storage medium may be integral to the processor. The processor and the non-transitory, tangible computer-readable storage medium may reside in an ASIC. The ASIC may reside in a user terminal. In the alternative, the processor and the non-transitory, tangible computer-readable storage medium may reside as discrete components in a user terminal. In some embodiments, a software module may be implemented as digital logic components such as those in an FPGA once programmed with the software module.

It is contemplated that one or more of the components or subcomponents described in relation to the computer system 400 shown in FIG. 4 such as, but not limited to, the network 430, processor 401, memory, 403, etc., may comprise a cloud computing system. In one such system, front-end systems such as input devices 433 may provide information to back-end platforms such as servers (e.g., computer systems 400) and storage (e.g., memory 403). Software (i.e., middleware) may enable interaction between the front-end and back-end systems, with the back-end system providing services and online network storage to multiple front-end clients. For example, a software-as-a-service (SAAS) model may implement such a cloud-computing system. In such a system, users may operate software located on back-end servers through the use of a front-end software application such as, but not limited to, a web browser.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system configured for verifying data, the system comprising one or more hardware processors configured by machine-readable instructions to:
generate one or more data values associated with one or more computing device interactions;
apply validation rules to the one or more data values; and
use the validation rules to verify whether at least one of the one or more data values comprises at least one allowable data value.

2. The system of claim 1, wherein the one or more data values comprise new data values and the system is further configured by machine-readable instructions to:
capture data associated with a plurality of computing device first events, the plurality of computing device first events comprising events occurring before the new data values associated with the one or more computing device interactions are generated;
process the data associated with the plurality of computing device first events to obtain the at least one allowable data value;
store the data associated with the plurality of computing device first events, and the allowable data value, with a data collection server system; and
store the new data values with the data collection server system after generating the new data values, wherein the one or more computing device interactions comprise one or more second events.

3. A method of verifying data, the method comprising,
capturing data associated with a plurality of computing device first events;
obtaining at least one allowable data value associated with the plurality of computing device first events;
interacting with the computing device in one or more second events;
generating new data values associated with the one or more second events; and
verifying whether the new data values comprise at least one of the at least one allowable data value.

4. The method of claim 3 further comprising,
storing the data with a data collection server system after capturing data associated with the plurality of computing device first events;
storing the at least one allowable data value with the data collection server system after obtaining one or more allowable data values, wherein, the one more allowable data values comprise values associated with at least one of the plurality of computing device first events and a manually provided data value; and
storing the new data values with the data collection server system after generating new data values associated with the one or more second events.

5. The method of claim 4, wherein
verifying whether the new data values comprise the at least one allowable data value comprises:
running a script on the computing device, wherein,
the script applies validation rules to the new data values, and
the validation rules comprise rules:
developed from one of processing the data associated with the plurality of computing device first events and manually provided from a user,
received at the computing device from the data collection server system, and
stored on the computing device.

6. The method of claim 5 wherein the validation rules comprise policies for:
identifying an event type for the one or more second events;
identifying one or more digital touchpoints associated with the one or more second events;
determining whether consent has been granted to allow operation of the one or more second events;
determining whether the one or more second events comprise an allowed event;
checking whether the new data values comprise personally identifiable information; and
determining whether the one or more second events are associated with one or more of a unique:
user,
vendor,
device, and
network; and
the validation rules provided from a user comprise rules for determining consent of the one or more computing device interactions.

7. The method of claim 6 wherein the plurality of computing device first events and plurality of second events comprise at least one of,
selecting a feature on one of a website and an application;
moving information on a user display to enable the display of new information;
entering information onto one of a website and application;
providing user consent related to collected information;
a network request;
a network request response;
changes or interactions with a document object model;
loading of a domain; and
launching of one of an application and an application feature.

8. The method of claim 5 wherein,
processing the data associated with the plurality of computing device first events comprises one or more of:
identifying a digital touchpoint asset associated with the data;
identifying at least one of a visitor, a visit, a web page, and an event associated with the data;
determining the frequency of, and a most frequent value for, a particular data point across:
similar computing device first events, and
one of the entire digital touchpoint and a portion of the digital touchpoint; and
using the frequency of one or more data points across similar computing device first events for the entire digital touchpoint to determine whether the one or more data points comprise one or more required data values or one or more optional data values;
identifying that consent associated with the plurality of computing device first events has been granted; and
further comprising identifying the one or more allowable data values associated with the plurality of computing device first events comprises one or more of,
identifying the digital touchpoint,
identifying at least one of the visitor, the visit, the web page, and the event, and
identifying at least one of the frequency of a particular data point comprises a frequency above a pre-identified threshold frequency and the most frequent value.

9. The method of claim 8 wherein,
the similar computing device first events comprise events where at least a portion of at least one feature associated with the events are the same; and
the at least one feature comprises at least one of:
one or more URL components, wherein the one or more URL components comprise at least one of a server-side URL, protocol, a domain, a port, a path name, a query string, a hash fragment, and a data payload,
performance information about page load,
network request load times,
network request data, wherein the network request data comprises at least one of a protocol, a domain, a port, a path name, a query string, a hash fragment, and a data payload,
cookie information,
JavaScript/JSON variables on the digital touchpoint,
one or more values associated with a document object model on the digital touchpoint,
one or more event element attributes, wherein the one or more event element attributes comprises at least one of an HTML ID, a class name, XPath, and a text value,
a current state of consent values provided by the user,
a size and total number of network requests on a page,
at least one of deployment of a technology type directly on the digital touchpoint and use of one or more of a piggy backed technology and a sub-loaded technology,
a mobile application screen; and
a digital touchpoint storage capability.

10. The method of claim 8 wherein, identifying the one or more allowable data values further comprises determining allowable data values for the plurality of computing device first events by:
determining a data type associated with the data, wherein the data type comprises one of a string, a number, a date, an array, and an object;
identifying a data pattern associated with the data type, wherein,
the identified data pattern associated with the string comprises at least one of a date format, a phone number, an email address, an individual's name, and a credit card,
the identified data pattern associated with the number comprises at least one of a positive number, a negative number, an integer, a floating-point number, and an identified length,
the identified data pattern associated with the array comprises at least one of an array element data type and a length,
the identified data pattern associated with the object comprises one or more sub-variables and one or more types of the one or more sub-variables, and
the identified data pattern associated with the date comprises a specific date range;
identifying a relationship between different computing device first events by determining whether one or more user actions on the digital touchpoint triggers at least one of the computing device first events, wherein the one or more user actions comprises at least one of a timing interval action, changing the document object model, a lack of user interaction with the digital touchpoint, a device attribute action, a manually-triggered user action, a user location, and at least one of a network request and a response from the network request; and
identifying a relationship between different data, wherein the relationship between the different data comprises sourcing at least part of the different data from at least one of a URL, one or more JavaScript variables in the document object model, a cookie, one or more digital touchpoint assets, a network request or a response to a network request, HTML elements, device information, location information, timing information, user input, and a digital touchpoint storage capability.

11. The method of claim 5, further comprising:
sending information related to the difference to the data collection server system; and
notifying a user of the difference between the new data values and the at least one allowable data value.

12. The method of claim 11 further comprising receiving a response from the user, wherein the response identifies the difference as one of,
an acceptable data value, and
an unacceptable data value.

13. The method of claim 12 wherein,
one of a website and an application associated with the computing device comprises a digital touchpoint;
notifying a user of the difference between the new data values and the at least one allowable data value comprises providing a notification related to one or more of:
a percent of total amount of new values comprising the difference,
a percent of new values associated with the digital touchpoint comprising the difference,
the number of new values across at least one of an entire digital touchpoint and an identified portion of the digital touchpoint comprising the difference,
an event type associated with the difference,
a network request type associated with the difference,
device attributes associated with the difference,
one of a time and a time window associated with the difference;
the difference comprises at least one of,
missing data,
malformed data,
unanticipated data, and
new data,
a user location associated with the difference;
a state of one or more of a document object model and a JavaScript associated with the document object model.

14. The method of claim 13, wherein,
when the response from the user comprises an acceptable data value, the method further comprises adding the difference to the at least one stored allowable data value; and
using the difference in the at least one stored allowable data value to identify one or more future data values as an allowable data value.

15. The method of claim 5 wherein capturing data associated with a plurality of computing device first events comprises,
using the script to capture data associated with the plurality of computing device first events; and
sending the data to the data collection server system to update the one or more allowable data values used by a root controller.

16. The method of claim 3 wherein
the at least one allowable data value comprises at least one value which enables one or more computing device features; and
the one or more computing device features are associated with one or more of,
an application installed on the computing device,
a website accessed by the computing device,
a server processing environment, wherein the server processing environment comprises the computing device,
a mobile application accessed by the computing device,
an application programming interface utilized by the computing device.

17. The method of claim 3, further comprising:
transmitting the new data values from the computing device;
wherein,
the at least one allowable data value comprises at least one data value associated with a response to the transmitting the new data values from the computing device;
the response comprises a response from a third party;
the response comprises response data values; and
wherein the method further comprises:
receiving the response at the computing device, and
verifying whether the response data values comprise at least one of the at least one allowable data value.

18. The method of claim 3 wherein,
the plurality of computing device first events comprises,
a first event type, and
one or more prior events; and
the one or more second events comprise,
one or more current events, the one or more current events comprising one or more events later in time as compared to the more or more prior events, and
at least one of the one or more second events comprises the first event type.

19. A non-transient computer-readable storage medium having instructions embodied thereon, the instructions being executable by one or more processors to perform a method for verifying data, the method comprising:
capturing data associated with a plurality of computing device first events;
obtaining at least one allowable data value associated with the plurality of computing device first events;
interacting with the computing device in one or more second events;
generating new data values associated with the one or more second events; and
verifying whether the new data values comprise at least one of the at least one allowable data value.

20. A system configured for verifying consent, the system comprising one or more hardware processors configured by machine-readable instructions to:
generate one or more data values associated with one or more computing device interactions;
apply consent rules to the one or more data values; and
use the consent rules to verify whether a user has at least one of granted consent and denied consent to transmit the at least one of the one or more data values.
